(19) United States
(12) Patent Application Publication
(10) Pub. No.: US 2025/0124404 A1
(43) Pub. Date: Apr. 17, 2025

(54) SYSTEMS AND METHODS FOR SPECIMEN IDENTIFICATION, MANAGEMENT, AND PROCEDURE MONITORING

(71) Applicant: CryoFuture, Inc., San Mateo, CA (US)

(72) Inventors: Cherie Soyoung KLOSS, Atlanta, GA (US); Sean Dongwey PAE, Atlanta, GA (US)

(73) Assignee: CryoFuture, Inc., San Mateo, CA (US)

(21) Appl. No.: 18/913,244

(22) Filed: Oct. 11, 2024

Related U.S. Application Data
(60) Provisional application No. 63/589,872, filed on Oct. 12, 2023.

(51) Int. Cl. G06Q 10/087; F17C 13/00; F17C 13/02; G06Q 10/10

(52) U.S. Cl. CPC G06Q 10/087; F17C 13/001; F17C 13/02; G06Q 10/10; F17C 2203/0366; F17C 2205/058; F17C 2250/038

(57) ABSTRACT

A method and related system for specimen identification, management, and procedural monitoring are described. Specimens can be cryogenic samples, housed in cryogenic containers having attached, integral, or physically included RFID tags, which can be scanned using an RFID scanner, while the cryogenic containers with samples are in the cryogenic fluid. Inventory tracking of the samples in the cryogenic containers can be performed with a computing device based on scanning the RFID tags. Also described are a method and related system that include a microscopic camera and one or more display screens and allow efficient and accurate identification of sample identifiable information on the sample, two-person verification from a central and remote locations, e.g., via videoconferencing capability, documentation, monitoring (e.g., quality control), and training. A method and related system for monitoring a procedure, e.g., a microscopic procedure, at two or more locations using microscopic camera and computing devices are also provided.

### CROSS-REFERENCE TO RELATED APPLICATION

This application claims the benefit of priority to U.S. Provisional Application No. 63/589,872, filed on Oct. 12, 2023. The entire contents of the foregoing application are hereby incorporated herein by reference.

### FIELD OF THE INVENTION

The instant disclosure relates generally to systems and methods for specimen identification, inventory management, and procedure monitoring.

### BACKGROUND

Sample identity verification, for example by reading small labels on samples, has been a manual, error-prone labor requiring verifying personnel's presence on site. Similarly, monitoring microscopic procedures has typically required on-site presence, and direct monitoring has been difficult even on site due to the microscopic nature of the procedure.

For example, cryogenic storage of embryos for fertility treatment of patients (e.g., clients of a fertility clinic) desiring pregnancy, and cryogenic storage of various tissues and biological samples, are in widespread use today. Cryogenic storage of biological samples is in use in medicine, research and education, and plays a vital role in reliably preserving biological samples short-term, medium-term and long-term (e.g., for later use or awaiting further medical and/or scientific developments). Intake, tracking, inventory, check out, check in, verification and other procedures involving information about the cryogenic samples are typically performed manually with one or more technicians visually observing handwritten or printed labels on samples and entering information into a database.

For example, one standard process used in cryogenic storage of embryos is to have one or preferably two technicians (to reduce error) manually inventory every specimen in the lab, at specified intervals (e.g., annual inventory). Typically, each specimen cane is assigned to a specific patient/customer/client and could have up to 20 specimens. Canes with specimens therein are stored in liquid nitrogen tanks, and a given facility could have, e.g., one hundred tanks each with 100-1000 specimens. A technician takes out each individual cane, visually inspects, and reads out information on a hand-written or printed label on the cane (often with tiny letters/characters). The same or another technician then writes the information down and/or manually enters the information into a computer database (e.g., through user input devices such as keyboard and mouse).

### SUMMARY

Various embodiments of a method for inventory tracking using cryogenic containers, and related systems, are described herein.

In one embodiment, a method for inventory tracking using cryogenic containers is described. The method includes maintaining samples in cryogenic containers having attached, integral or physically included RFID tags, at least partially submerged in cryogenic fluid. The method includes scanning, using an RFID scanner, the RFID tags of the cryogenic containers while the cryogenic containers with samples are in the cryogenic fluid. The method includes performing inventory tracking of the samples in the cryogenic containers, with a computing device, based on the scanning the RFID tags of the cryogenic containers.

One embodiment is a system for inventory tracking using cryogenic containers. The system includes RFID tags attached to, integral with, or physically included in cryogenic containers. The system includes an RFID scanner. The system includes at least one computing device having memory, capability of coupling to the RFID scanners, and a processor arranged to perform a method. The method includes receiving, from the RFID scanner, scans of the RFID tags of the cryogenic containers while the cryogenic containers, containing samples, are maintained at least partially submerged in cryogenic fluid. The method includes performing inventory tracking of the samples in the cryogenic containers, using a database in the memory, based on the received scans of the RFID tags of the cryogenic containers.

One embodiment is a tangible, non-transitory, computer-readable media. The media has instructions thereupon which, when executed by a processor, cause the processor to perform a method. The method includes receiving, from an RFID scanner, scans of RFID tags of cryogenic containers while the cryogenic containers, having the RFID tags and containing samples, are maintained at least partially submerged in cryogenic fluid. The method includes performing inventory tracking of the samples in the cryogenic containers, using a database in memory, based on the received scans of the RFID tags of the cryogenic containers. The method includes generating reports relating to the inventory tracking of the samples in the cryogenic containers.

One embodiment is a method for inventory tracking using cryogenic containers. The method includes maintaining samples in cryogenic containers having attached, integral or physically included RFID tags, at least partially submerged in cryogenic fluid in cryogenic tanks. The method includes scanning, using at least one RFID scanner, the RFID tags of the cryogenic containers while the cryogenic containers with samples are kept in the cryogenic fluid. The method includes scanning, using at least one further RFID scanner, to detect RFID tags of cryogenic containers that are arriving to or exiting from a region comprising the cryogenic tanks. The method includes performing inventory tracking of the samples in the cryogenic containers, including automated check-in and automated checkout, with a computing device, based on the scanning the RFID tags of the cryogenic containers and the scanning the RFID tags of the cryogenic containers that are arriving or exiting.

One embodiment is a system for inventory tracking using cryogenic containers. The system includes RFID tags attached to, integral with, or physically included in cryogenic containers. The system includes at least one RFID scanner and at least one further RFID scanner. The system includes at least one computing device having memory, capability of coupling to the RFID scanners, and a processor arranged to perform a method. The method includes receiving, from the at least one RFID scanner, scans of the RFID tags of the cryogenic containers while the cryogenic containers, containing samples, are maintained at least partially submerged in cryogenic fluid in cryogenic tanks. The method includes receiving, from the at least one further RFID scanner, scans that detect RFID tags of cryogenic containers that are arriving to or exiting from a region comprising the cryogenic tanks. The method includes performing inventory tracking of the samples in the cryogenic containers, including automated check-in and automated checkout, based on the received scans of the RFID tags of the cryogenic containers in the cryogenic tanks and the received scans that detect the RFID tags of the cryogenic containers that are arriving or exiting.

One embodiment is a tangible, non-transitory, computer-readable media having instructions thereupon which, when executed by a processor, cause the processor to perform a method. The method includes receiving, from at least one RFID scanner, scans of RFID tags of cryogenic containers while the cryogenic containers, having the RFID tags and containing samples, are maintained at least partially submerged in cryogenic fluid in cryogenic tanks. The method includes receiving, from at least one further RFID scanner, scans that detect RFID tags of cryogenic containers that are arriving to or exiting from a region comprising the cryogenic tanks. The method includes performing inventory tracking of the samples in the cryogenic containers, including automated check-in and automated checkout, based on the received scans of the RFID tags of the cryogenic containers in the cryogenic tanks and the received scans that detect the RFID tags of the cryogenic containers that are arriving or exiting. The method includes generating reports relating to the inventory tracking of the samples in the cryogenic containers.

Various embodiments of a method and a system for verifying identity of a sample or monitoring a procedure using a microscope camera are described herein.

In one embodiment, a method for verifying identity of a sample is described. The method includes placing the sample for visualization under a microscope camera at a central location, and identifying the information on the label displayed on the screen, thereby verifying identity of the sample. The sample has an attached, integral, or physically included label. The label contains sample identifiable information thereon. The microscope camera is connected to a first display screen, such that the label is displayed on the first display screen. In some embodiments, the method further includes providing the sample identifiable information captured by the microscope camera to be displayed on a second display screen at a remote location through an information transmittal system connected to the microscope camera, and verifying the sample identifiable information at the remote location based on the remotely provided sample identifiable information, independently from the identification of the sample at the central location. In some embodiments, the information transmittal system comprises: a first computing device having memory and a processor, the first computing device connected to the microscope camera; a network capable of information transmittal and connected to the first computing device; and a second computing device having memory and a processor and connected to the network and the second display screen. In some embodiments, the information transmittal system is a video conferencing system.

One embodiment is a system for verifying identity of a sample. The system includes a microscope camera at a central location, to capture sample identifiable information that is attached to, integral to, or physically included in the sample; a first display screen connected to the microscope camera, to visualize the sample identifiable information; a first computing device having memory and a processor, the first computing device connected to the microscope camera; a network capable of information transmittal connected to the first computing device; a second computing device having memory and a processor connected to the network; and a second display screen at a remote location. The second display screen is connected to the second computing device and arranged to display the sample identifiable information captured by the microscope camera and transmitted through the first computing device, the network, and the second computing device, such that the sample identifiable information can be verified at the remote location based on the remotely provided sample identifiable information, independently from verification of the sample at the central location. In some embodiments, the microscope camera is a flexible microscope camera. In some embodiments, the microscope camera has a magnification rate of about 5 to about 10 times. In some embodiments, the system includes video conferencing capability between the central location and the remote location. In some embodiments, the system includes recording capability of the sample identifiable information captured by the microscope camera. In some embodiments, the recording includes capturing and storing an image of the sample identifiable information captured by the microscope camera. In some embodiments, the system further includes: a magnifying lens at the central location, to locate and/or verify the sample identifiable information; a verification table at the central location, to place the sample thereon for verification; and/or a verification bath on the verification table, to place the sample therein for verification. In some embodiments, the verification table has an adjustable height.

One embodiment is a method for monitoring a procedure. The method includes: capturing the procedure with a microscope camera at a central location; visualizing the procedure on a first display screen connected to the microscope; and visualizing the procedure on a second screen at a remote location through an information transmittal system connected to the microscope camera, thereby monitoring the procedure at the central location and the remote location. In some embodiments, the microscope camera is a flexible microscope camera. In some embodiments, the microscope camera has a magnification rate of about 5 to about 10 times. In some embodiments, the information transmittal system comprises: a first computing device having memory and a processor, the first computing device connected to the microscope camera; a network capable of information transmittal and connected to the first computing device; and a second computing device having memory and a processor and connected to the network and the second display screen. In some embodiments, the information transmittal system is a video conferencing system. In some embodiments, the method further includes recording the procedure through the microscope camera. In some embodiments, the method further includes placing the recorded procedure in an inventory system or a documentation system. In some embodiments, the sample is a medical sample, and the documentation system comprises medical records. In some embodiments, the method further includes conducting quality assurance and/or training using the monitoring or recording of the procedure. In some embodiments, the procedure includes verifying identity of a sample.

In some embodiments, the sample is a cryogenic sample, such as a specimen cane containing a fertility specimen. In some embodiments, the label has capability of surviving intact in cryogenic storage for at least one year. In some embodiments, the sample is immersed in cryogenic liquid in a verification bath during the steps of verifying identity of the sample.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a system diagram of an embodiment of an RFID system for inventory tracking of cryogenic samples, which can be used for fertility specimen identification.

FIG. 2 depicts an RFID tag placed on a specimen cane that includes one or more goblets each containing a biological sample, e.g., an embryo, for cryogenic storage using the system of FIG. 1 or variation thereof.

FIG. 3 depicts an example RFID tag, which can be used as shown in FIG. 2 and in the system of FIG. 1.

FIG. 4 depicts the cane of FIG. 2 placed in liquid nitrogen for cryogenic storage.

FIG. 5 depicts a handheld RFID scanner scanning RFID tags of specimen canes that are in a cryogenic tank.

FIG. 6 depicts an inventory report generated by the system of FIG. 1, as viewable on a handheld device or other display device.

FIG. 7A depicts an example RFID specimen lookup report generated by the system of FIG. 1, as viewable on a handheld device or other display device.

FIG. 7B further depicts an example RFID specimen lookup report generated by the system of FIG. 1, as viewable on a handheld device or other display device.

FIG. 8 illustrates an example technical data flow in the system of FIG. 1 or further embodiment.

FIG. 9A is a flow diagram of a method of operation of an RFID system for inventory tracking of cryogenic samples.

FIG. 9B is a flow diagram of a method of operation of an RFID system for inventory tracking of cryogenic samples.

FIG. 10 depicts a system for verifying identify of a sample, such as a fertility specimen, according to embodiments provided herein.

FIG. 11 depicts a sample placed under a flexible microscope camera in a verification bath on a verification table, according to embodiments provided herein.

FIG. 12 depicts a magnifying lens and the sample with a label thereunder, according to embodiments provided herein.

FIG. 13 depicts a display screen displaying a label on the sample, such as a specimen cane, according to embodiments provided herein.

FIG. 14 depicts a display screen displaying a label on the sample, such as a specimen straw, according to embodiments provided herein.

FIG. 15 depicts a display screen connected to the flexible microscope and a computing device, placed on a verification table with adjustable height, according to embodiments provided herein.

FIG. 16 is a flow diagram of an example method of verifying identity of a sample.

FIG. 17 is a flow diagram of an example method of monitoring a procedure.

### DETAILED DESCRIPTION

Described herein are embodiments of various methods and systems for verifying identity of a sample (e.g., a cryogenic sample, e.g., a fertility specimen). The systems and methods include a microscopic camera and one or more display screens to allow efficient and accurate identification of sample identifiable information on the sample. The systems and methods can include computing devices and a network, which enable two-person verification from a central and remote locations, e.g., via videoconferencing capability, documentation, monitoring (e.g., quality control), and training. Embodiments of various methods and systems for monitoring a procedure, e.g., a microscopic procedure, at two or more locations using microscopic camera and computing devices are also described herein.

Also described herein are embodiments of various systems and methods for use with cryogenic storage of samples. Represented herein are technological solutions and technological improvements over known processes and systems in cryogenic storage of biological samples, including tissue samples and cryogenically frozen embryos, which can reduce human error and decrease risk of incorrect information, loss, misplacement, accidental thawing and other damage to samples. Thereby, safety to cryogenically stored samples is improved upon, liability for labs and clinics is reduced, and confidence that patients, customers and clients have of clinics and labs can be increased. The amount of time it takes for inventory can be greatly reduced, and inventory tracking thus partially or fully automated.

Existing techniques for managing and identifying samples fail to provide reliable, accurate, and efficient identification and management of samples. For example, existing systems and techniques may use an inventory process that takes days, and may introduce human error including mis-entry of information for a given sample or associated to an incorrect sample, misplacing samples, thawing a sample (e.g., it may take one second to thaw, nitrogen may spill, a specimen could fall out, the embryo could de-crystallize), etc. In the event of a misplaced specimen, technicians would search manually in all of the cryogenic (liquid nitrogen) tanks, further introducing possibility of human error as above. In light of the risks of human error, the exposure of various facilities and personnel to liability, and the potential suffering of patients, customers or clients due to loss or misplacement of sample, complications in pregnancy or birth defects in an infant brought to term and delivered, there is a need in the art for a technological solution or improvement which overcomes the drawbacks described above. It is in this environment that presently described embodiments arise.

### A. Radio Frequency Identification (RFID) System

In one system (and related method) for cryogenic storage of biological samples, data for an RFID tag is created in an app, for example herein termed the signal app (e.g., CryoFuture Signal app). New specimens can be tagged by creating a new RFID label, for example using the signal app. This will associate all future scans of a specific RFID tag with data according to the linked specimen and patient. This label (i.e., physical RFID tag and associated data) is unique to this specimen and will allow users, for example managers, to track and monitor for any issues.

The RFID tag is placed on a specimen cane, which is a type of container for biological specimens. Each cane can contain one or more goblets, which is a type of container for an individual specimen. In some embodiments, the placement of the RFID tag is on a goblet, which may be the uppermost goblet in a set of goblets in a cane. The RFID tag provides for accurate scanning and identification of the specimen(s) held in or by the cane.

The cane, with RFID tag, is then placed in liquid nitrogen for storage, which may be shorter, medium or longer-term cryogenic storage. Special RFID tags that can withstand the harsh temperatures for years are used in various embodiments.

The RFID tag can be scanned inside or outside of the cryogenic tank. RFID tags can be scanned in bulk with a handheld or fixed reader inside or outside of the tank. This ensures that managers can quickly take inventory, identify issues, and take appropriate action.

The signal app returns bulk data. Once a manager has scanned a set of labels using the handheld RFID scanner, the bulk inventory data will be returned. This allows the managers to take inventory of hundreds of specimens in seconds, easily reconcile discrepancies and generate report of inventory. The report is viewable on the handheld or in the platform.

Once a manager has scanned a label using the handheld RFID scanner, the specimen and patient data will be returned. This information is viewable on the handheld or in platform. This system eliminates the need to remove specimens from the tank, simply open the lid and easily lookup patient information via an RFID tag.

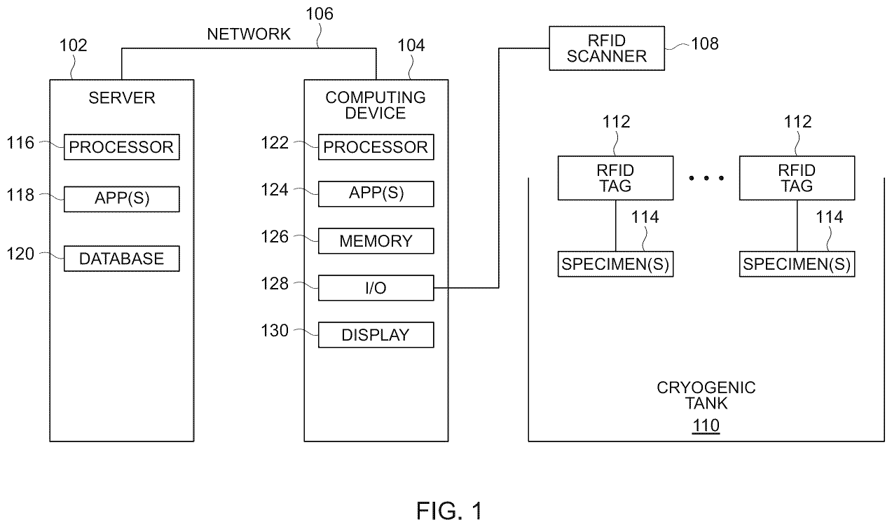

FIG. 1 is a system diagram of an embodiment of an RFID system for inventory tracking of cryogenic samples, which can be used for fertility specimen identification. For example, cryogenic storage biological samples for fertility medicine could be eggs, sperm, fertilized eggs, embryos, tissues, cells, cell cultures, etc. For other medical, research, education, etc. use, cryogenic storage biological samples could be the above or other types of tissues, cells, cancer cells, bone marrow cells, blood, etc.

The system can make use of various processor-equipped devices and programming, here shown as apps, and various hardware equipment for RFID scanning of RFID tags 112 associated to specimens 114 in cryogenic storage in a cryogenic tank 110. There may be multiple cryogenic tanks 110 in a given system.

An RFID scanner 108 is coupled through I/O 128 to a computing device 104, and this coupling could be wired or wireless for example. Alternatively the computing device 104 and RFID scanner 108 are integrated, for example a complete self-contained handheld RFID scanner. The computing device 104 has a processor 122, memory 126, and one or more apps 124 for example executing on the processor 122 using the memory 126 and processing data of the RFID scanner 108. A display 130 may be separate from or integrated with the computing device 104, and used for displaying data, for example reports generated by the system.

In this embodiment, the computing device 104 is coupled to a server 102 through a network 106, which could be local, wireless, wired, and/or the globally connected network known as the Internet, for example. The server 102 has a processor 116, one or more apps 118, and a database 120. Processing information from the RFID scanner 108 as communicated to the server 102, the server 102 can populate the database 120, and communicate back to the computing device 104 with information processed from the database, such as reports. Alternatively, the computing device 104 could have the database 120, and perform the information processing and report generating. Further embodiments combining the various pieces of equipment, distributing equipment into a distributed system or using virtual computing on physical processing devices, as further systems, are readily envisioned in maintaining with the teachings herein.

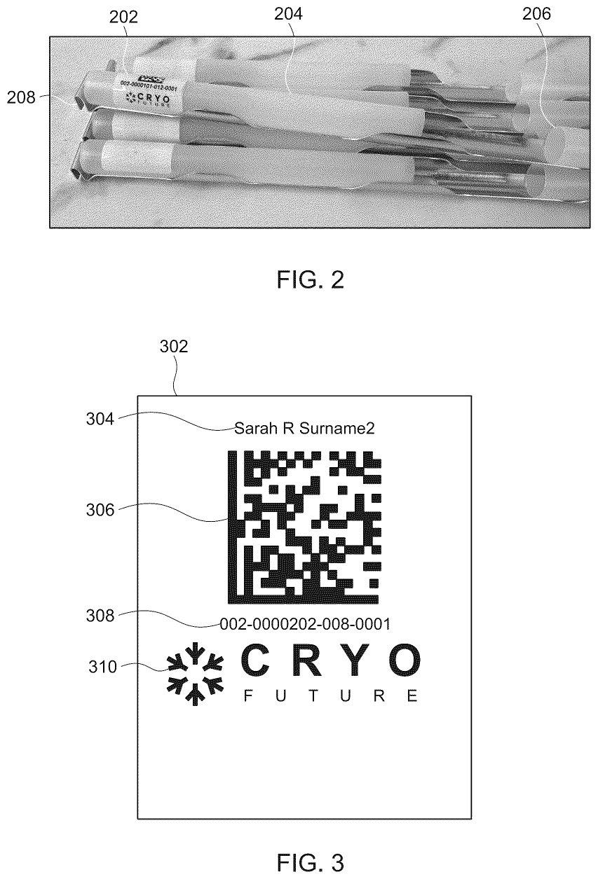

For example, in one embodiment a computing device has all of the functionality of the server 102, the computing device 104, and is wirelessly or wired coupled to an RFID scanner. In one embodiment, a single, handheld device has all of the functionality of the server 102, the computing device 104 and the RFID scanner 108. In one embodiment, multiple RFID scanners are used, including a handheld RFID scanner for scanning RFID tags 112 of or associated to specimens 114 in the cryogenic tank 110 (e.g., see FIGS. 2-5), and one or more RFID scanners that can be positioned at doorways or other entrance or exit of a room to monitor arrival or departure of specimens with RFID tags from that room (e.g., a cryogenic storage room with multiple cryogenic storage tanks 110). In one embodiment, the system automates check-in, checkout and inventory of specimens 114, through use of doorway-mounted RFID scanners and one or more portable RFID scanners, or alternatively RFID scanners mounted to cryogenic storage tanks 110. Appropriate apps 118, 124 are arranged, for example through specially programmed computer(s), installation (e.g., local or download) from tangible, computer-readable media, etc., to perform various functions, such as transferring scans from RFID scanner 108 to memory 126 of the computing device 104, entry, storage and retrieval of information of relevance to the specimens 114 associated to RFID data, in the database 120 of the server 102, generating reports, data processing including verification, error detection, diagnostics, etc., displaying information, user entry of information, importing data, exporting data, and further functions as readily understood in maintaining with the teachings herein, etc.

Various operating scenarios are readily devised and understood, and appropriate apps 118, 124 developed for supporting these operating scenarios, along with various components appropriate to the embodiments. In one operating scenario, a technician uses an RFID scanner 108 to check in one or more specimens 114 in association with a respective RFID tag 112. The specimen(s) 114 are arriving for cryogenic storage, and are then placed in a cryogenic tank 110 in an appropriate container along with the RFID tag 112 (see FIGS. 2-5). A technician uses an RFID scanner 108 (e.g., the same, or a differing unit) to scan RFID tags 112 of or associated with specimens 114 in the cryogenic tank 110, while these specimens and RFID tags remain in situ (i.e., in the cryogenic tank 110 with cryogenic fluid). A technician uses an RFID scanner 108 (e.g., the same, or a differing unit) to scan the RFID tag 112 of or associated with specimen(s) 114 that are exiting cryogenic storage, for example for use by a doctor with a patient in a fertility clinic, or for research, education, etc. The system uses these RFID scans for inventory tracking the specimens 114, including check-in, inventorying of all specimens in cryogenic storage, and check out.

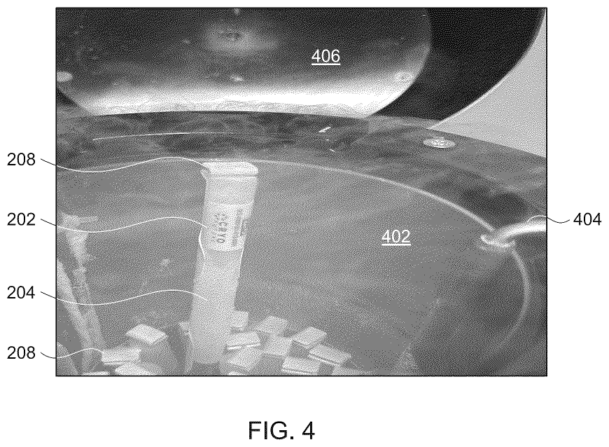

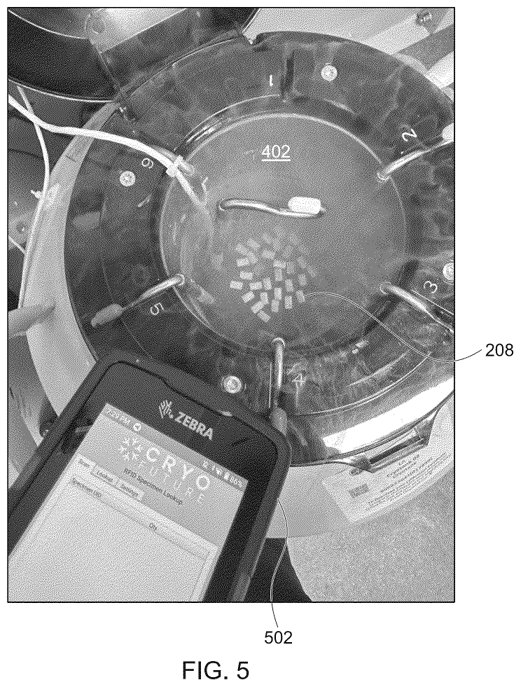

In an automated operating scenario, RFID scanner(s) 108 are attached to cryogenic tank(s) 110, and further RFID scanner(s) 108 are attached to doorway(s) (e.g., entrances and exits) of a cryogenic storage facility room in which cryogenic tank(s) 110 are located. The system automatically scans RFID tags 112 of arriving specimens (e.g., specimen(s) in a specimen cane 204 with RFID tag 202 as depicted in FIG. 2) using the RFID scanner(s) 108 located at a boundary of a region. The system automatically scans RFID tags 112 of specimens 114 in cryogenic tank(s) 110 (see FIGS. 4 and 5) using RFID scanner(s) 108 attached to cryogenic tank(s) 110. The system automatically scans RFID tags 112 of exiting specimens 114 (e.g. in specimen cane 204, see FIG. 2), using the RFID scanner(s) 108 located at the boundary of the region. The system uses these RFID scans for automated inventory tracking the specimens 114, including automated check-in, automated inventorying of all specimens in cryogenic storage, and automated checkout. Such automated check-in and automated checkout are performed by detecting RFID tags 112 of specimens 114 entering or exiting the cryogenic storage facility room (i.e., crossing the boundary of the region). In some embodiments, the range of the RFID scanner is configured to align with the boundary region.

Variations on the above scenarios, for combinations of manual scans and automated scans, using handheld and mounted RFID scanners, are readily devised. Appropriate equipment for the above-described and variation scenarios is understood, and may involve handheld RFID scanners, fixed mounted RFID scanners, antennas for same coupled to distributed components, etc.

FIG. 2 depicts an RFID tag 202 placed on a specimen cane 204 that includes one or more goblets 206 each containing a biological sample, e.g., an embryo, for cryogenic storage using the system of FIG. 1 or variation thereof. A metal hook 208 or other end-fixture at the top or upper end of the specimen cane 204 is arranged to engage a tool for insertion or retrieval of the specimen cane 204 into or out of a cryogenic tank. Typically, the metal hook 208 of each cane 204 in the tank for cryogenic storage is upwards, so that such a tool can engage the metal hook 208, and the specimen cane 204 is oriented more or less vertically with specimens lower down and fully immersed in liquid nitrogen. Also, with this orientation, the RFID tag 202 is at or near the uppermost portion of the cane 204, which may facilitate reading by an RFID scanner in comparison to locating an RFID tag 202 lower or immersed in the liquid nitrogen.

In one embodiment, the specimen cane 204 has two or more goblets 206 therein. The uppermost goblet 206 has an RFID tag 202 attached to, or integral with the goblet 206. One or more goblets 206 that are below the uppermost goblet 206 in the cane 204, each have a biological sample therein. With this arrangement, the uppermost goblet 206 protects the lower goblet(s) 206 from spillage or loss. And, the uppermost goblet 206 with the RFID tag 202 is closer to an RFID scanner and may sit above the level of the liquid nitrogen in the cryogenic tank, which improves scan reliability. Also in this arrangement, all of the biological samples in the respective goblets 206 in a given cane 204 are associated to a single patient, client or customer, e.g., of a clinic. This association is represented in the single RFID tag 202 of the specimen cane 204. Note further with this arrangement, a specific cane 204 can be reassigned a different RFID tag 202 through replacement of the uppermost goblet 206 with differing RFID tag 202.

In another embodiment, the RFID tag 202 is attached to, or integral with the specimen cane 204, preferably at an upper end of the cane 204 for similar reasons as above. Each possible arrangement of RFID tag 202, cane 204, and goblets 206 may have advantages and disadvantages.

FIG. 3 depicts an example RFID tag 302, which can be used as shown in FIG. 2 and in the system of FIG. 1. An RFID antenna and RFID chip, with transponder and memory functionality, are embedded in the RFID tag 302 and thus not visible in the drawing, but are readily understood to form a transponder that responds to the RFID scanner. Visible information on the RFID tag 302, e.g., for visual inspection by a technician, may be in the form of handwritten or printed text, symbols or geometries. Such visible information in this example includes a patient/customer/client name 304, a two dimensional barcode 306 for optical barcode scanning, an identification number or code (e.g., alphanumeric), and a company symbol and logo 310. Other visible information is readily understood and devised. In some embodiments, the visible information corresponds to or may be identical to information transmitted by the RFID tag 302 during a scan, and can be used for visual confirmation of scan results. Visible information is also a backup in case of failure of the RFID scan, data loss in a computing system or other technical problem.

FIG. 4 depicts the cane 204 of FIG. 2 placed in liquid nitrogen for cryogenic storage. This particular cane 204 is shown elevated in comparison to other canes in storage, the metal hooks 208 of which are visible above the level of cryogenic fluid (e.g., liquid nitrogen) in the cryogenic tank 402. The metal hook 208 of the particular cane 204 is elevated relative to the others, perhaps upon insertion or removal of the cane 204, although an insertion/removal tool is title not visible but is readily understood. A cryogenic fluid fill pipe 404 is visible to the right in the drawing, and the lid 406 of the cryogenic tank 402 is in an open position.

FIG. 5 depicts a handheld RFID scanner 502 scanning RFID tags of specimen canes that are in a cryogenic tank 402. Metal hooks 208 of canes are visible. It should be noted that the RFID tags, and in particular the printed information on the RFID tags, do not need to be visible in order for RFID scanning to be successful with the canes in situ.

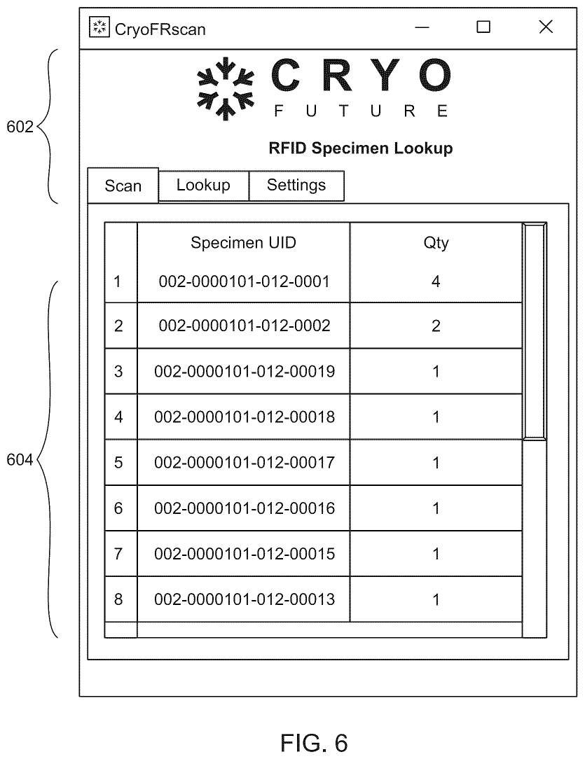

FIG. 6 depicts an inventory report generated by the system of FIG. 1, as viewable on a handheld device or other display device. For example, the inventory report could be generated by the server 102, the computing device 104, or both in cooperation, and displayed on the display device 130 of the computing device 104, or other display such as a smart phone, the RFID scanner 108 if display equipped, another computing device, another network or wireless coupled device, etc.

In this example, the inventory report shows a header 602 with symbols and/or text identifying the system, a company, a facility, etc. and/or a page title, here “RFID Specimen Lookup” informing the user as to the contents of the inventory report. Listed in the inventory report are scans 604, more specifically information about a group of scans, for instance scans of all RFID tags in a given cryogenic tank 110. Included are scan numbers, specimen universal identifiers (Specimen UID), and quantities of specimens associated with UIDs. There may be more than one page of scans 604. The user can select a specific scan, and the system generates a report with information for that scan.

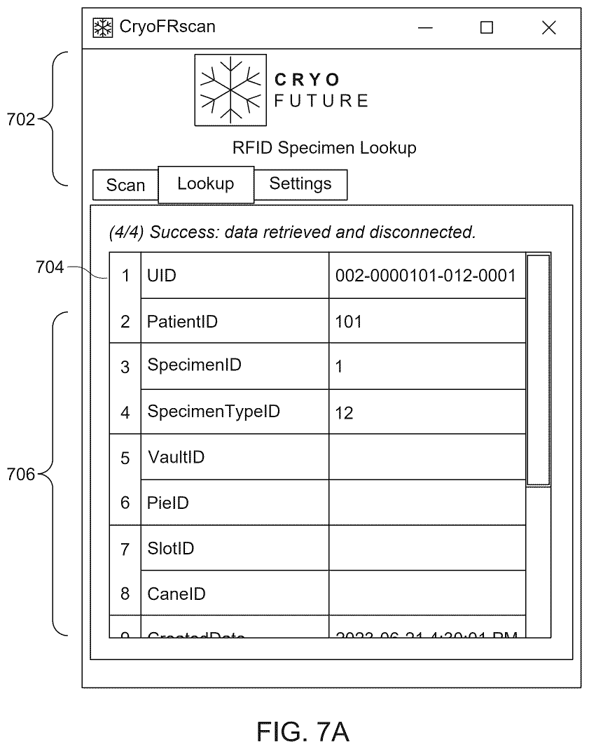

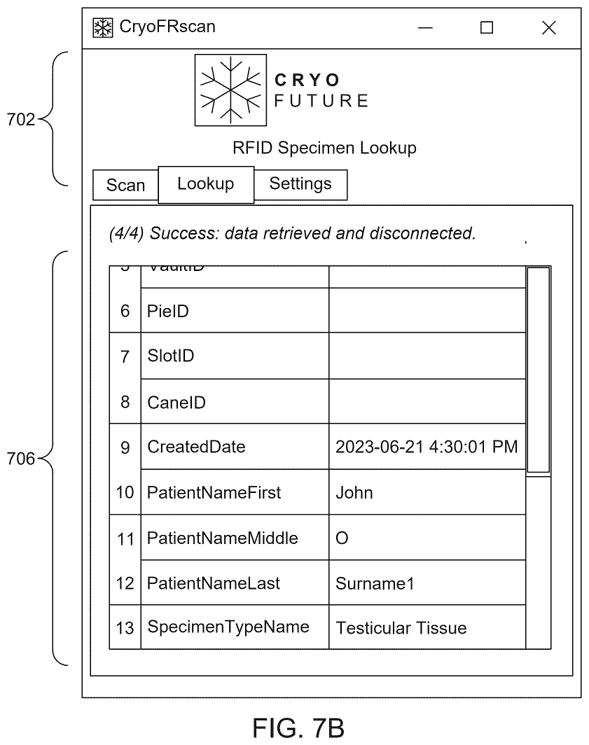

FIG. 7A depicts an example RFID specimen lookup report generated by the system of FIG. 1, as viewable on a handheld device or other display device. This report shows a header 702, which may be identical to, similar to, or different from the header 602 of the inventory report. For example, in some embodiments, the header(s) are personalized for users of the system, e.g. listing a clinic or laboratory name, etc. Listed in the RFID specimen lookup report are a scan 704, which was selected from the scans 604 of the inventory report, and information in specimen fields 706 associated to that specific scan (e.g., in database 120, associated to that RFID tag through data thereof). In this example such information includes a patient identifier, specimen identifier, specimen type identifier, a vault identifier, a pie identifier, a slot identifier and a cane identifier. There may be more information than shows up on a single page, as depicted below.

FIG. 7B further depicts an example RFID specimen lookup report generated by the system of FIG. 1, as viewable on a handheld device or other display device. Further specimen fields 706 in this example have information including a create date, a patient first name, a patient middle name, a patient last name, a specimen type name. Variations on the information in a scan and a report are readily understood for further embodiments.

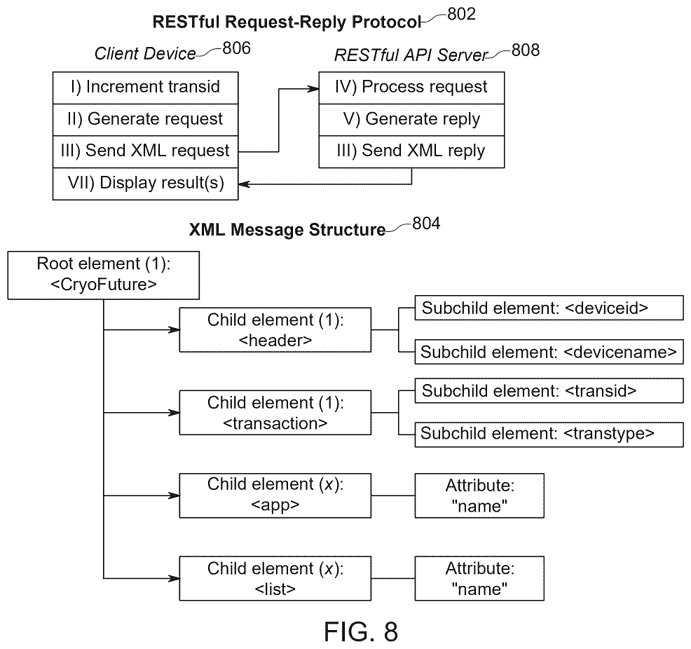

FIG. 8 illustrates an example technical data flow in the system of FIG. 1 or further embodiment. In the data flow, a client device 806 (e.g., computing device 104 of FIG. 1, or variation thereof) and a server 808, herein named RESTful API (application programming interface) Server because it is executing a specific application programming interface, are communicating with each other in a RESTful Request-Reply protocol 802. Communication uses an XML message structure 804, or variation thereof. The client device generates and sends a request, in this example an XML request, to the server 808, which processes the request, generates a reply, and sends the reply, in this example an XML reply, to the client device 806. Further embodiments with various protocols, programming, etc. are readily devised in maintaining with the teachings herein. Specifics are described for this example, and a system embodiment, in detail below. Roman Numerals I-VII in the example(s) and embodiment(s) below may correspond to Roman Numerals I, II, III and VII of client device 806 in FIG. 8, and Roman Numerals IV, V and VI in Server 808 of FIG. 8. Examples of XML format and elements below may correspond to XML message structure 804 in FIG. 8.

### RESTful API for (RFID) Data Exchange

Request-Reply protocol in XML (extensible markup language) format:

The XML format may utilize XML message version “1.0” and encoding “utf-8”.

The XML format may utilize lowercase elements and attributes only, apart from the root element <CryoFuture> or other name. The XML root element may represent the XML document that is being mapped. The XML root element may be a looping structure that contains elements and content particles that repeat in sequence until either the group data ends or the maximum number of times that the loop is permitted to repeat is exhausted.

In the XML format, the first child element may be the header element <header>.

In the XML format, next child element (after the header) may exist and may be the transaction element in the XML format the <transaction>.

In some embodiments, additional subsequent child elements, if existent (are optional), can be in any order.

In some embodiments, there can be multiple additional child elements in one XML message, i.e. multiple lists.

In some embodiments, the Transaction ID<transid> in the transaction element is incremented on the client's device on every new request, is non-volatile, and may be returned by the REST server in its reply so the client knows which request was processed.

In some embodiments, the REST server may remember the Transaction ID<transid> in conjunction with the transaction date <date> and ignore duplicate transactions from the same client. However, in some embodiments the REST server may not assume that the Transaction ID is always sequential.

In some embodiments, the Transaction ID will be randomly generated on the client device on install (and therefore can start initially with any value), then incremented on every new request, and saved to non-volatile flash after every increment.

In some embodiments, the REST server may check the UserID and the associated privileges of the received message before a transaction. The user may exist in the users table and the privileges are not set to zero (0). Users with privileges set to zero (0) may have been revoked access and they cannot perform any transactions or requests, in some embodiments.

In some embodiments, a message with a User ID of zero (0) is a system/app generated request and the REST server may allow such requests (e.g., as long as the device is authenticated).

In some embodiments, the REST server may be multithreaded so it can process multiple client requests at the same time.

In some embodiments every user initiated transaction (User ID of non-zero) may be recorded in the transaction table.

To be able to print from the REST server, in one embodiment the REST server sends the appropriate data to a server or computing device, such as a Windows server or Windows PC, for example via an open TCP (Transmission Control Protocol) port. The server, in one example termed the Nicelabel Automation Server, may be used for printing labels.

In some embodiments, all subchild elements are text unless otherwise specified, such as INT (32-bit integer value) or HEX (32-bit hexadecimal value starting with 0x).

In some embodiments, the server reply may be transmitted on the same TCP port as the incoming port.

In some embodiments, the client keeps the transmission port open, the server may close the port after it has sent its reply on the same port.

In some embodiments, the client may be able to read multiple TCP packets per XML message, but the XML message may start and end with the CryoFuture root element or other root element.

In some embodiments, the client may set an appropriate limit on the maximum number of bytes allowed per XML message to prevent buffer overflows and potential exploits. The limit may be set based on the client's available memory.

The server may ignore or return an error if the XML message is not according to spec.

In some embodiments there is a

Header Element <header>

Header element may be required for every single packet sent by the client or server. It identifies the device that initiated the communication.

In some embodiments, there can only be one header element per XML message.

From client (subchild elements, request III):

| XML element | Example | Description | Required |
|---|---|---|---|
| deviceid | e7c7-0000-000046bffd97 | Unique device Identifier (ID) | ALWAYS |
| devicename | Mobile #10 | Device description | No |

From REST (subchild elements, reply VI):

| XML element | Example | Description | Required |
|---|---|---|---|
| deviceid | RESTAPI10 | Server name and API version | ALWAYS |
| devicename | REST Server (San Mateo) | Server description and location | No |

In some embodiments, Device ID (deviceid or device identifier) is an unique fingerprint that will not change even after the app is uninstalled (but may change on factory reset or firmware upgrade). It can be used to allow access or deny access to the database (activation or deactivation), for example to prevent unauthorized installs. Device name (devicename) is additional information that can be used to identify the device (such as an asset label

App Element <app name=“attribute”>

In some embodiments, the app element is optional and can be used for acquiring additional device information and for informing the clients of new settings or a new available app version. The exchange sequence for this element may be determined; for example the client could transmit this at startup and then whenever settings change, or reply to the server whenever it receives a server app element. The client will only ever send one app element but the server may send multiple app elements for different OSes. In some embodiments, both the client and server only need to read one app element, the client will only read the relevant one for its OS and the server should assume the app element received is the correct one for the client device.

In some embodiments, there can be multiple app elements per message but only one app element per specified attribute per XML message (the client will only read the relevant one for its OS).

In some embodiments, the attribute determines the type of OS for which the app element is intended, in the example below the information is meant for Android devices only. In further embodiments, there is support for other platforms.

In some embodiments, from client (subchild elements, attribute=android, request III):

| XML element | Example | Description | Required |
|---|---|---|---|
| appversion | v2.1.10 | App version in use (major.minor.revision) | ALWAYS |
| appoptions (HEX) | 0x0A05 | Current app settings | ALWAYS |
| osversion | Android 13 | Version of installed device Operating System | No |
| osbuild | TQ2A.230505.002 | Installed device OS firmware build | No |
| | | (device specific) | |
| hwtype | Google Pixel 7 | Device's hardware; type and model | No |

In some embodiments, from REST (subchild elements, attribute=android, reply VI):

| XML element | Example | Description | Required |
|---|---|---|---|
| appversion | v2.1.12 | App version available (major.minor.revision) | ALWAYS |
| appoptions (HEX) | 0x0005 | App specific settings | ALWAYS |
| executable | Base64 binary data | App executable (on Android APK or AAB file) | TRANS1 |

Transaction Element <transaction>

Transaction element may be used for every single packet sent by the client or server. The client formats this element based on the user driven action or it can be system driven. The server responds to this by copying the original data and appending the result of the data processing, in one embodiment. There can only be one header element per XML message, in some embodiments.

It is recommended to read ALL specified transaction elements on every XML message receive (not all elements may be present), even if some elements are not required for a specific transaction.

In some embodiments, from client (subchild elements, request III):

| XML element | Example | Description | Required |
|---|---|---|---|
| transid (INT) | 1012 | Unique transaction ID, auto incremented, | ALWAYS |
| | | device dependent (random start on install) | |
| transtype | SPEC-MOVE | Request type for this transaction | ALWAYS |
| userid (INT) | 1003 | User/operator identifier or zero (0) for system | ALWAYS |
| specuid | 002-0000321-012-0001 | Unique ID of the specimen (UID) | TRANS |
| patientid (INT) | 321 | Unique ID of the patient associated with | TRANS |
| | | the specimen | |
| patientname | Dave Surname3 | Name of patient associated with the patientid | No |
| date | 2023-06-21T16:30:08-07:00 | Timestamp of the request (ISO 8601) | ALWAYS |
| data1 | TankID = 20 | Additional transaction data, optional and | No |
| | | transtype dependent | |
| data2 | SlotID = 16 | Additional transaction data, optional and | No |
| | | transtype dependent | |
| data3 | UnitID = 11 | Additional transaction data, optional and | No |
| | | transtype dependent, read until no more | |

In some embodiments, Transaction ID (transid) is incremented by the client device on every new action (request) that is sent to the REST server, so it knows together with the date if this is a new or already processed request. Note that the Transaction ID for different devices can be the same, although rare, so only in combination with the timestamp will it be unique.

In some embodiments, the initial Transaction ID value is randomly generated on install to prevent it from being the same after a re-install. The Transaction Type (transtype) should always be in a list of supported transactions and if unrecognized a failure should be returned.

In some embodiments, a request with a User ID (userid) of zero (0) is generated by the app or system itself and not a user driven request, i.e. the app wants to know the latest available software version or requests a list.

The server may check that the transid, transtype, and the userid are valid. These may exist in any XML message and have valid values.

The User ID (userid) is either zero (for app system) or should be a valid ID in the users table with valid privileges/permissions (TBD), in some embodiments. If the User ID is not valid, or the user does not have the correct permissions, then a failure should be returned.

For the Transaction ID (transid) the value should always be higher than zero and be incremental from message to message, in some embodiments. If a message with the same Transaction ID is received by the server with the timestamp, then the server should return a successful result if the transtype is the same (the server assuming that the reply was never received by the client even though the request was successfully processed by the server). If the transtype is NOT the same then a failure should be returned, in some embodiments.

In some embodiments, the date subchild element may be present and is needed for transactions that alter the database, and should be written to the date field of the transaction table. For transactions that do not alter the database, such as requesting a list, this element will still be present so the server may calculate latency, or the server may completely ignore it.

If Required is set to “TRANS” then the requirement is dependent on the type of transaction, some transactions will require it, some not, and the server should check that this element is present on a transaction basis, in some embodiments.

ALWAYS implies the element should always be present, for every transaction, and the REST server should check that those elements exist for every received message, and the server should return a failure message if not present. This is so in some embodiments, and not in others.

The client may remember all the details of the transaction when it is returned by the REST server, so no additional data other than the transaction ID and the result need to be returned. It is recommended that the server also returns the date that the transaction was processed or when the message was compiled, for latency reasons, and some embodiments.

Additional transactional data depends on the type of transaction and the server should read it until there is no more, and in some embodiments the data will be sequentially numbered, i.e. data1, data2, data3, etc. (stop when the next subchild element is NOT present, e.g., in the previous example data4 is missing).

In some embodiments, from REST (subchild elements, reply VI, successful transaction):

| XML element | Example | Description | Required |
|---|---|---|---|
| transid | 1012 | Returned transid from the processed request | ALWAYS |
| transtype | SPEC-MOVE | Returned transaction type from the processed | ALWAYS |
| | | request | |
| date | 2023-06-21T16:30:11-07:00 | Timestamp of the reply (ISO 8601) | No |
| result | SUCCESS | Transaction result of the processed request | ALWAYS |

In some embodiments, from REST (subchild elements, reply VI, transaction failure):

| XML element | Example | Description | Required |
|---|---|---|---|
| Transid | 1012 | Returned transid from the processed request | ALWAYS |
| transtype | SPEC-MOVE | Returned transaction type from the processed | ALWAYS |
| | | request | |
| Date | 2023-06-21T16:30:11-07:00 | Timestamp of the reply (ISO 8601) | No |
| result | FAILURE: Slot already | Transaction result of the processed request. | ALWAYS |
| | contains specimen(s) from | On failure is appended with reason. | |
| | other patient! | | |

In some embodiments, from REST (subchild elements, reply VI, transaction failure):

| transtype | description |
|---|---|
| APP-VERSION | Request app element from server (server can add this element any time) |
| APP-DOWNLD | Request new app executable (server returns APK or AAB on Android) |
| TYPEALL | Retrieve all type lists in one transaction - see Supported lists: |
| SPEC-MOVE | Move specimen to a (different) storage location (vault,tank,unit,slot) |
| SPEC-XFER | Transfer specimen to a different facility or a clinic |
| TBL-UPDATE | Update SQL database table column value |

In some embodiments, from client (subchild elements, request III):

| child element | | Example | Description |
|---|---|---|---|
| transaction | | | |
| | transid | 1030 | New transaction ID |
| | transtype | APP-VERSION | Client request latest available version from server |
| | userid | 0 | System initiated the request (system userid = 0) |
| | date | 2023-06-21T16:30:13-07:00 | Timestamp from client |
| app | | Client will always append app element with its own details when requesting | |
| | appversion | v2.1.10 | App version in use (major.minor.revision) |
| | appoptions | 0x0A05 | Current app settings |
| | osversion | Android 13 | Version of installed client Operating System |
| | osbuild | TQ2A.230505.002 | Installed device OS firmware build (client specific) |
| | hwtype | Google Pixel 7 | Client's hardware; type and model |

In some embodiments, from server (subchild elements, reply VI):

| child element | | Example | Description |
|---|---|---|---|
| transaction | | | |
| | transid | 1030 | Returned transaction ID |
| | transtype | APP-VERSION | Returned request transaction type |
| | date | 2023-06-21T16:30:13-07:03 | Timestamp from server |
| app | | Server returns its app element when returning | |
| | appversion | v2.1.12 | App version available (major.minor.revision) |
| | appoptions | 0x0005 | App specific settings; (could force install etc.) |

In some embodiments, from client (subchild elements, request III):

| child element | | Example | Description |
|---|---|---|---|
| transaction | | | |
| | transid | 1031 | New transaction ID |
| | transtype | APP-DOWNLD | Request version from server |
| | userid | 0 | System initiated the request (system userid = 0) |
| | date | 2023-06-21T16:30:13-07:00 | Timestamp from client |

In some embodiments, from server (subchild elements, reply VI):

| child element | | Example | Description |
|---|---|---|---|
| transaction | | | |
| | transid | 1031 | Returned transaction ID |
| | transtype | APP-DOWNLD | Returned request transaction type |
| | date | 2023-06-21T16:30:13-07:03 | Timestamp from server |
| app | | Server returns its app element when returning | |
| | appversion | v2.1.12 | App version available (major.minor.revision) |
| | appoptions | 0x0005 | App specific settings; (could force install etc.) |
| | executable | file = ”CRFscan.v2112.apk” | Attribute for executable element specifies filename |
| | | Q1JGc2Nhbi52MTAuYXBr | Binary file data encoded in base64 |

| child element | | Example | Description |
|---|---|---|---|
| transaction | | | |
| | transid | 1033 | Returned transaction ID |
| | transtype | SPEC-MOVE | Returned request transaction type |
| | specuid | 002-0000321-012-0001 | Unique ID of the specimen (UID) |
| | date | 2023-06-21T16:30:13-07:03 | Timestamp from client |

data subchild element for SPEC-MOVE transaction

| Format: | <datax> | One table column per data element separated by an equals (=) sign, in ANY order and in | |
|---|---|---|---|
| | | ANY combination. This allows the REST server to easily check value limits instead of | |
| | | sending one SQL string. | |
| <data> | TankID | Move/Set TankID for specimen | REST Server should check the tank exists |
| | SlotID | Move/Set SlotID for specimen | REST Server should check the slot exists for the tank |
| | UnitID | Move/Set UnitID for specimen | REST Server should check the unit exists for the tank |
| | | | Canister ID or Rack ID, depending on tank type |
| | PieColor | Move/Set PieColor for specimen | REST Server should check the pie exists for the tank |

| | | |
|---|---|---|
| Example: | <data1>UnitID = 11</data1> | Specimen was moved to a different canister and slot for |
| | <data2>SlotID = 16</data2> | a floor tank, but in the same tank. |

data subchild element for TBL-UPDATE transaction

| Format: | <datax> | One combination per data element separated by an equals (=) sign, in ANY order but | |
|---|---|---|---|
| | | always four data elements. | |
| <data> | table | Table to alter | REST Server should check the table exists |
| | id | Unique ID of table item | Unique index of table item |
| | column | Column value to change | REST Server should check the column may be changed |
| | value | Value to set column to | New value of column |
| Example: | | <data1>table = tank_types</data1> | Column “description” in “tank_types” may be changed |
| | | <data2>column = description</data2> | since it's a description, but for example the “TankType” |
| | | <data3>value = Floor Tank</data3> | column is unique and should never be changed |
| | | <data4>id = 100</data4> | |

List Element <list name=“attribute”>

In some embodiments, the list element is used to gather table results from a server database lookup. It is formatted in rows and columns with the first row being the table header (columns names) and the following rows being the actual column data (each row identifying as a different entry).

In some embodiments, multiple list elements per XML message are allowed.

The attribute may determine what the table is and where the data is used or displayed on the device.

In some embodiments, from client (subchild elements, request III):

| | | Notes (see header element paragraph for | [symbol] quired (this |
|---|---|---|---|
| XML element | Example | description) | [symbol] example) |
| transid (INT) | 1013 | New transaction ID | YES |
| transtype | LIST-SPECIMEN | Request patient info list | YES |
| userid (INT) | 1003 | User/operator with this ID initiated the request | YES |
| patientid (INT) | 321 | Lookup patient info with this Unique ID | YES |
| date | 2023-06-21T16:30:08-07:00 | Timestamp of the request (ISO 8601) | No |
| data1 | TankID = 20 | May be blank or optional lookup parameters | No |

[symbol]

indicates data missing or illegible when filed

The list transaction can have additional lookup data (data1) which is dependent on the type of list requested. It may indicate additional search parameters, such as return a list with male specimen types only, or in the example above, the client asks for all specimens that are in tank 20 for the specified patient.

The above example from the client describes what is required for this particular example and is dependent on the requested transaction type. The returned structure from the REST server below is an example of what could be returned although it does mention what is always required for any list type.

The REST server may format the results in the same way for each specified list, with the first row always being the column names and subsequent rows being the actual data. For request with no results, but the request being valid, the server may only return the first row with the valid column names and no subsequent rows. If the server query failed then a FAILURE result may be returned and not an empty list. An empty list is not processed on the client side and just ignored.

In some embodiments, from REST (subchild elements, attribute=patient_info, reply VI):

| child element | Example | Description | Required |
|---|---|---|---|
| transaction | | | ALWAYS |
| transid | 1013 | Same transid as the initial request | ALWAYS |
| transtype | LIST-SPECIMEN | Same transtype as the initial request | ALWAYS |
| date | 2023-06-21T16:30:13-07:00 | Timestamp from server | No |
| row | First row always required, even for empty tables; indicates successful lookup | | ALWAYS |
| column | UID | Column 1 Name; blank permitted | No |
| column | FacilityID | Column 2 Name; blank permitted | No |
| column | PatientID | Column 3 Name; blank permitted | No |
| column | SpecimenTypeID | Column 4 Name; blank permitted | No |
| id | Specimen UID | Not used in table view but uniquely identifies this item | ALWAYS |
| | | in the database. Used for identification and used in | |
| | | transactions. | |
| name | Specimen UID | Not used in table view but uniquely identifies this item | ALWAYS |
| | | in the selectable list. Used for user selection. | |
| hint | | Hint associated with row item | No |
| row | Second row might be omitted if there are no results but action was successful | | No |
| column | 002-0000321-011-0003 | Column 1 data for <UID>; blank permitted | YES |
| column | 2 | Column 2 data for <FacilityID>; blank permitted | YES |
| column | 321 | Column 3 data for <PatientID>; blank permitted | YES |
| column | 11 | Column 4 data for <SpecimenTypeID>; blank | YES |
| | | permitted | |
| id | 002-0000321-011-0003 | This value uniquely identifies this table row in case of | YES |
| | | a selection | |
| name | 002-0000321-011-0003 | This name uniquely identifies this table row in case of | YES |
| | | a selection | |
| hint | | No associated hint | No |

In some embodiments, the number of subchild elements for each row may match, and both the “name” and “id” child element may exist in the first row and all subsequent rows. The hint subchild element is optional but recommended for certain lists.

In some embodiments, no empty rows are allowed, if the row child element is present then there may be at least one subchild (column) element. Do not add the list element to a XML message if the transaction failed, in some embodiments. Read columns and rows until no more.

### Supported Lists:

In some embodiments, all the lists of specific types (in blue font) can be retrieved all at once with the transaction: TYPEALL. There is no additional filtering for this request, all records should be obtained in different list elements.

| <list name = “attribute”> | | |
|---|---|---|
| transtype | attribute | description |
| LIST-USER | user_list | List of app users/operators at this facility; all if no additional transaction data |
| | | Format of additional data: Privilege value in HEX |
| LIST-FACILITY | facility_list | List of available facilities |
| | | Format of additional data: SQL WHERE string |
| LIST-CLINIC | clinic_list | List of available clinics |
| | | Format of additional data: SQL WHERE string |
| LIST-VAULT | vault_list | List of available vaults |
| | | Format of additional data: SQL WHERE string |
| LIST-TANK | tank_list | List of available tanks; all if no additional transaction data |
| | | Format of additional data: SQL WHERE string |
| LIST-PATIENT | patient_list | List of available patients |
| | | Format of additional data: SQL WHERE string |
| LIST-SPECIMEN | specimen_list | List of stored specimens; all if no additional transaction data |
| | | Format of additional data: SQL WHERE string |
| TYPE-SPEC | specimen_types | List of defined specimen types |
| | | Format of additional data: comma separated by: <type>, <gender> |
| TYPE-TANK | tank_types | List of defined tank types |
| | | Format of additional data: SQL WHERE string |

In some embodiments, most list transactions have additional (optional) data in the form of a SQL search string. The server is responsible to add this to the SQL statement and there is no actual “WHERE” in the additional data, just the conditional search parameters (if present at all). Unless specified, each list query will only have one additional data element (although like always, the REST server should read all additional data present).

For example, if <data1>FacilityID=1</data1> is added to the facility list request (LIST—FACILITY) then the server is responsible for formatting it correctly for the SQL query (in this example by adding “WHERE” in front of the received data.

The sorting of the returned lists is controlled by the REST server although the client could override this by sorting the list before it is displayed in a table or combobox. Normally how the data is displayed in the table is how it is returned by the server in the list with the first returned list row being the first displayed table row.

Required XML elements by List, for some embodiments:

Users list is slightly different from a generic list that is used for viewing or selecting in the sense that the app will expect certain columns to be present. This list can be requested by the system before an user is logged in. If the app is requesting this list (UserID=0) then no privileges check is necessary, otherwise (if UserID is not zero) the server should check that the user can actually see the list and in what capacity (see passwords? TBD).

| child element | Example | Client | Server |
|---|---|---|---|
| transaction | | | |
| transid | 1014 | Generated | Returned |
| transtype | LIST-USER | Requested | Returned |
| data1 | 0x08 | Hex value: get users with specified | Does not return |
| | | privilege bit set (all users if blank | List sorting is controlled by the |
| | | or omitted) | server |
| row | | | Returns all rows or none |
| column | password | | REQUIRED: login password |
| column | privileges | | REQUIRED: access permissions |
| id | id | | REQUIRED: unique user ID |
| name | name | | REQUIRED: displayed login name |
| row | | | Returns all rows or none |
| column | 1234 | | REQUIRED: login password |
| column | 0x0A | | REQUIRED: access permissions |
| id | 1003 | | REQUIRED: unique user ID |
| name | Brad S | | REQUIRED: displayed login name |

In some embodiments, additional data in the request (data1) for the user list, sent by the client, is in the form of a hexadecimal value specifying the privileges value of the users to get. All users that have this bit set (bitwise AND) should be returned. For example, the REST server query for the request above (with a requested privileges value bitmask of 0x08) should be similar to:

If this additional data is omitted from the query (not present) then all the users (apart from the local system account which has an UserID of zero) in the table should be returned.

In some embodiments, the privileges value is an 32-bit unsigned integer; administrators may have all bits set (the equivalent of −1 for a signed integer) thus allowing for a special mode that may give software access to additional features. The privileges value may limit access to certain functionality for each user. Once the user logs in on the software (app), the software may not constantly check if the privileges value has changed, and the server should always check this value in real-time when a transaction is received to make sure the user has the required permission. The app will update the users list only on initial startup or when any user logs off.

Example database table (userid with 0 is the system account):

| user | userid | loginname | password | privileges | id | name |
|---|---|---|---|---|---|---|
| Software Local System | 0 | SYSTEM | ^{null} | 0x0 | 0 | SYSTEM |
| System Administrator | 1000 | Admin | 1940 | 0xFFFFFFFF | 1000 | Admin |
| Operator #1 | 1001 | User1 | 1111 | 0x5 | 1001 | User1 |
| Operator #2 | 1002 | User2 | 2222 | 0x2 | 1002 | User2 |
| Operator #3 | 1003 | User3 | 3333 | 0xF | 1003 | User3 |
| Brad Smith | 1004 | Brad S | 4444 | 0xF | 1004 | Brad S |

For the examples below, additional data is omitted and only the required data for the example is shown. Normally also the database columns and their relevant data is returned.

| child element | Example | Client | Server |
|---|---|---|---|
| transaction | | | |
| transid | 1015 | Generated | Returned |
| transtype | LIST-FACILITY | Requested | Returned |
| data1 | FacilityID = 1 | SQL WHERE string (may be blank or | Does not return |
| | | omitted for all) | List sorting is controlled by the |
| | | | server |
| list: row | | | Returns all rows or none |
| id | 2 | | REQUIRED: FacilityID |
| name | San Mateo | | REQUIRED: FacilityName |
| hint | California Facility USA | | REQUIRED: Description |

| | |
|---|---|
| All table columns | Returns all columns |

| child element | Example | Client | Server |
|---|---|---|---|
| transaction | | | |
| transid | 1015 | Generated | Returned |
| transtype | LIST-CLINIC | Requested | Returned |
| data1 | ClinicID = 1 | SQL WHERE string (may be blank or | Does not return |
| | | omitted for all) | List sorting is controlled by the |
| | | | server |
| list: row | | | Returns all rows or none |
| id | 1 | | REQUIRED: ClinicID |
| name | Clinic A | | REQUIRED: ClinicName |
| hint | Primary Care Clinic in | | REQUIRED: Description |
| | LA | | |

| | |
|---|---|
| All table columns | Returns all columns |

| child element | Example | Client | Server |
|---|---|---|---|
| transaction | | | |
| transid | 1016 | Generated | Returned |
| transtype | LIST-VAULT | Requested | Returned |
| data1 | VaultID = 11 | SQL WHERE string (may be blank or | Does not return |
| | | omitted for all) | List sorting is controlled by the |
| | | | server |
| list: row | | | Returns all rows or none |
| id | 10 | | REQUIRED: VaultID |
| name | V002 | | REQUIRED: VaultName |
| hint | Vault #2 in basement | | REQUIRED: Description |
| | (North) | | |

| | |
|---|---|
| All table columns | Returns all columns |

| child element | Example | Client | Server |
|---|---|---|---|
| transaction | | | |
| transid | 1017 | Generated | Returned |
| transtype | LIST-TANK | Requested | Returned |
| data1 | TankType = 816 AND | SQL WHERE string (may be blank or | Does not return |
| | TankName = T020 | omitted for all) | List sorting is controlled by the |
| | | | server |
| list: row | | | Returns all rows or none |
| id | 20 | | REQUIRED: Unique TankID |
| name | T020 | | REQUIRED: TankName |
| hint | Left Tank in Vault #2 | | REQUIRED: Description |

| | |
|---|---|
| All table columns | Returns all columns |

| child element | Example | Client | Server |
|---|---|---|---|
| transaction | | | |
| transid | 1018 | Generated | Returned |
| transtype | LIST-PATIENT | Requested | Returned |
| data1 | PatientID = 101 | SQL WHERE string (may be blank or | Does not return |
| | | omitted for all) | List sorting is controlled by the |
| | | | server |
| list: row | | | Returns all rows or none |
| id | 101 | | REQUIRED: Unique PatientID |
| name | Surname1, John | | REQUIRED: displayed name |
| hint | John S | | REQUIRED: private name |

| | |
|---|---|
| All table columns | Returns all columns |

| child element | Example | Client | Server |
|---|---|---|---|
| transaction | | | |
| transid | 1019 | Generated | Returned |
| transtype | LIST-SPECIMEN | Requested | Returned |
| patientid | 101 | Request for Patient with ID: optional | Returned |
| | | for specific patient's specimen(s) | |
| specuid | 002-0000101-012-0001 | Request for SpecimenID: optional for | Returned |
| | | specific specimen | |
| data1 | SpecimentTypeID = 6 | SQL WHERE string (may be blank or | Does not return |
| | | omitted for all) | List sorting is controlled by the |
| | | | server |
| list: row | | | Returns all rows or none |
| id | 002-0000101-012-0001 | | REQUIRED: Specimen UID |
| name | 002-0000101-012-0001 | | REQUIRED: Specimen Name |
| hint | | | |

| | |
|---|---|
| All table columns | Returns all columns |

| child element | Example | Client | Server |
|---|---|---|---|
| transaction | | | |
| transid | 1020 | Generated | Returned |
| transtype | TYPE-SPEC | Requested | Returned |
| data1 | DONOR, F | comma separated string | Does not return |
| | | (may be blank or omitted | List sorting is controlled by the |
| | | for all) | server |
| list: row | | | Returns all rows or none |
| id | 2 | | REQUIRED: SpecimenTypeID |
| name | Donor Embryos/Embryos | | REQUIRED: SpecimenTypeName |
| hint | | | |

| | |
|---|---|
| All table columns | Optional: returns all columns |

data1 subchild element for TYPE-SPEC transaction

| Format: | <type> | Specific specimen types | comma separated values |
|---|---|---|---|
| | <gender> | Specimen types per gender | SELECT * FROM specimen_types (WHERE) |
| <type> | ALL | All types for specified gender(s) | (may also be blank) |
| | DONOR | All donor types | SpecimenTypeName LIKE ‘Donor%’ |
| | TISSUE | All tissue types | SpecimenTypeName LIKE ‘%Tissue%’ |
| | SELF | All non-donated and non-tissue | SpecimenTypeName NOT LIKE ‘%Tissue%’ AND |
| | | types | SpecimenTypeName NOT LIKE ‘Donor%’ |
| <gender> | A | All genders (may also be blank) | (SpecimenTypeID & 0x03) > 0 |
| | M | Male | (SpecimenTypeID & 0x02) > 0 |
| | F | Female | (SpecimenTypeID & 0x01) > 0 |
| Example: | | <data1>DONOR,F</data1> | SELECT * FROM specimen_types WHERE |
| | | | SpecimenTypeName LIKE ‘Donor%’ AND |
| | | | (SpecimenTypeID & 0x01) > 0 |

| child element | Example | Client | Server |
|---|---|---|---|
| transaction | | | |
| transid | 1020 | Generated | Returned |
| transtype | TYPE-TANK | Requested | Returned |
| data1 | TankType = 100 | SQL WHERE string (may | Does not return |
| | | be blank or omitted for all) | List sorting is controlled by the |
| | | | server |
| list: row | | | Returns all rows or none |
| id | 100 | | REQUIRED: TankType |
| name | Floor Tank | | REQUIRED: Description |
| hint | | | |

| | |
|---|---|
| All table columns | Returns all columns |

Below is an example RFID system guide, or one embodiment. Variations, using other components, names, etc. are readily devised in maintaining with the teachings herein.

### CryoFuture RFID System Guide

Introduction: The CryoFuture RFID system is used to catalogue and track specimens in our storage facility. The system can be used to create new labels as specimens come into our possession, track them as a part of our inventory during storage, and track them as they leave our facilities for transport.

### Hardware Requirements (One Embodiment):

Windows PC/Laptop
Zebra MC3300 Handheld RFID Scanner
Zebra ZD621R UHF RFID Thermal-Transfer/Direct Thermal Printer
RFID Cryo-WrapTAG™—Wrap-Around Cryogenic Thermal-Transfer Labels—1×1+1.625″

### Software Requirements (One Embodiment):

Nicelabel Automation Server script <CF-DatabaseServer.misx> (Windows background service)
MySQL Server 8.0 instance with cryofuture_assetdb schema
MySQL ODBC 8.0 Unicode Driver
Zebra Keyboard Datawedge app (pre-installed on handheld)

### Data Flow (One Embodiment):

1. MC3300 handheld scans 2D barcode or RFID tag
2. Datawedge transmits data to app (local TCP port 58627)
3. CryoFRscan app filters CryoFuture programmed codes only (displayed on scan page)
4. App will send the code to the Nicelabel Automation Server for a lookup (remote TCP port 58700, IP address is configurable in the app)
5. The Nicelabel Server will perform a lookup in the MySQL database and return the results to the app (the Nicelabel Server and MySQL database should be on the same computer)
6. The app will display the returned results as it is received on the Lookup page

### Terminology

Code refers to a barcode or RFID code that was programmed by CryoFuture equipment with an unique prefix value (“CRF”).

CryoFuture specific codes can be of a different type (determined by the fourth prefix value) and include specimen codes (“CRFS”).

RFID scanner refers to the integrated RFID antenna reader inside the Zebra MC300 handheld.

Barcode scanner refers to the integrated imager inside the Zebra MC300 handheld.

Server refers to Nicelabel Automation Server that processes and replies to the app's requests.

### Nicelabel Automation Server Script Installation

The Automation Server is part of Nicelabel PowerForms and will be automatically installed on default when Nicelabel 10 is installed (make sure Automation and Designer is checked though). It is a service that runs in the background and will start automatically with Windows.

After installation of Nicelabel, copy the file <CF-DatabaseServer.misx>, which is the script for our app, to a sensible location on the server (not a network folder unless you use a domain or local user with network access, the local system account does not have network access). Then open the Nicelabel Automation Manager, press “Add” in Configurations and select the copied .misx file. Finally press the start button on the TCP/IP server for that imported configuration and it should turn green to indicate that it is active. It should now automatically restart on every computer reboot. At any stage, the status of the Nicelabel Automation Server can be seen in the Automation Manager.

### Zebra Keyboard Datawedge Configuration

The Datawedge app should already be installed on the Zebra handheld, it comes pre-installed from the manufacturer. It will just require configuration so the scanned data is sent to the CryoFRscan app the correct way.

Copy the <CryoFRscan-Datawedge.db> file to the device's Download folder, then open the Datawedge app, click on “Settings” and then “Import Profile.” Browse to do Download folder on the device and then import the file.

You should now see the imported profile “CryoFRscan-Datawedge.”

The profile should be enabled on default and it should already be associated with the CryoFRscan app, but it is good to check that they are anyway.

If the RFID scanner and the barcode scanner are physically working but no data is received in the app, then these are the two obvious reasons as to why it is not working.

### App User Pages

There are three main pages in the app, the Scan page, the Lookup page, and the Settings page.

The Scan page is used for displaying scan results, in a scan table, from the RFID scanner and the barcode scanner. Since the information is the same in both codes, the information displayed is the same and no distinction between the two is visible. If the barcode scanner is used to capture data then there is normally only one result captured per scan trigger in the table on the Scan page. The RFID reader is capable of reading multiple tags at the same time and therefore there can be multiple codes being captured at the same time (per scan trigger).

What happens next depends on the configured app settings (see Settings page). If the parameter “Auto Lookup Trigger” is zero (0) then the app will not automatically trigger a lookup and the scanned codes will sit accumulated in the scan table waiting for the operator to select a code and perform a manual lookup. The scan table will be cleared when a reply from the server is received.

With the parameter “Auto Lookup Trigger” set to a value higher than zero (0) then the app will automatically trigger and perform a lookup after it has not received any new data after the specified “Auto Lookup Trigger” time. On every data packet received from the Datawedge, the timer is reset and restarted. Once the timer has elapsed a lookup of the code with the highest scan quantity (top table row) is performed. The scan table will be cleared when a reply from the server is received.

The Lookup page is used for displaying results, in a lookup table, from the code lookup; currently only specimen codes are supported. The results are displayed in rows and in order as they are received from the Nicelabel Server. The lookup table is cleared on every data packet received.

The Settings page is used for configuring app specific settings. Default settings are used on initial install for all of the parameters, but not all of them are changeable. Changing any settings will take effect immediately and there is no need to restart the app (or handheld) after changing them.

The app title and version is also displayed on this page (major, minor, build).

### Scan Page

Press the trigger button on the handheld to scan the barcode or the RFID label/tag. When scanning, multiple specimen codes (UID=Unique IDentifier) can show up in the scan table (as shown in the examples below). The number of times the same code is scanned is shown as the quantity (Qty), with the highest quantity showing on top of the table (automatically sorted). In case of an RFID scan the most scanned code is usually the label that is physically the closest.

If the app has been set to have a manual lookup trigger (“Auto Lookup Trigger=0” on the settings page) then there won't be an automatic lookup of the most scanned code, but rather a manual lookup is necessary. This can be achieved by selecting a valid table row and maintaining it continuously pressed for one second (only releasing the row selection after the specified time). A popup menu will now appear with a selection of actions, select “Lookup Item” and the selected code will be sent to the server for a database lookup.

The manual selecting of a code is not necessary when automatic lookup trigger is enabled. In that case the code with the highest number of scans is automatically selected and sent to the server for a database lookup.

For both a manual and automatic lookup, the app will automatically switch to the lookup page on receiving data from the server.

The scan table is cleared on every new scan trigger but can also be cleared manually from the popup menu (press and hold any table row for at least one second).

### Lookup Page

This page displays the specimen lookup results received from the server. If no lookup has been sent to the server then the status text in blue will mention that the connection is currently idle, otherwise progress of the server communication will be shown.

When a code has been sent to the server for a lookup then the status will be updated with one (1) to four (4) steps:
Step 1: Trying to connect to the server
Step 2: Connected to server and waiting for lookup results
Step 3: Data received from server and processing results
Step 4: Connection to server was closed

If the steps are not displayed in the status message then this indicates an error condition or the connection being idle, with an appropriate description such as the failure reason. For example, if the scanned code is not present in the database then an error would be shown to acknowledge this.

On successful retrieval of the specimen code's database results, all the information is displayed as shown below. How the information is shown, and what, is totally dependent on the server. The app displays the information as received. You can scroll up or down to view all the results.

On every new lookup the results table will be cleared, but to manually clear the table, press and hold anywhere in the table for at least one second and then select “Clear Table” from the popup menu.

### Settings Page

On this page the app specific configuration can be changed. Changing any of the parameters here will take immediate effect and the settings are automatically saved to non-volatile storage (app specific cache).

Datawedge Port The port that the Zebra Keyboard Wedge app uses to transmit the data to this app. The app will listen on this fixed port (58627) for scanned (incoming) data.

Auto Lookup Trigger The time (in milliseconds) permitted between data arriving from the Datawedge. If no more new data arrives after this time then the app will perform an auto code lookup.

Set this value to zero (0) to disable automatic lookup and enable manual lookup mode.

Server IP Address This is the IP address (IPv4) of the server. It is recommended that the IP address of the server is set to static to prevent it from changing.

Lookup requests are sent to this IP address on the fixed port (58700).

Font Size This is the default font size (in points) used for the app. Increase or decrease this value to make the fonts more legible and to optimize the app layout.

Some fonts in the app are of different sizes (bigger or smaller than the default) and those will be scaled appropriately to the default size.

Use the Android keyboard or the up and down arrows to change each of the parameter's values.

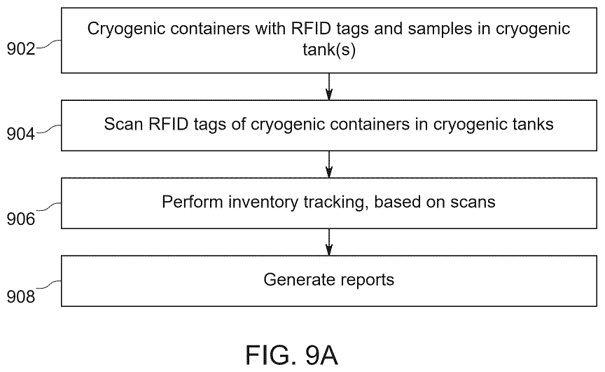

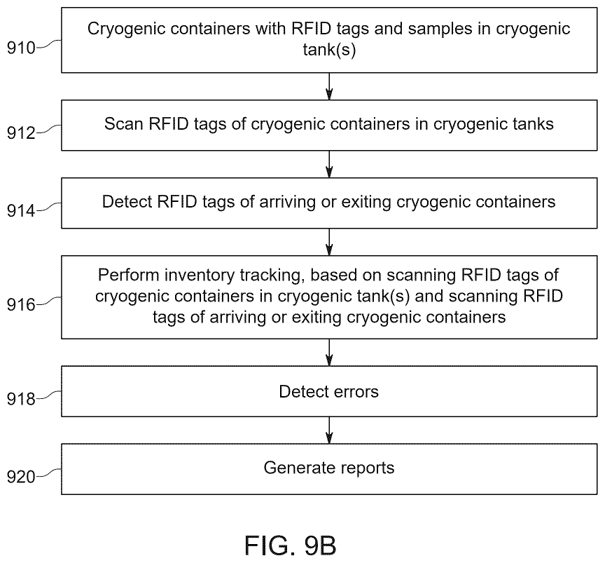

FIG. 9A is a flow diagram of a method of operation of an RFID system for inventory tracking of cryogenic samples. As used herein in describing both FIG. 9A and FIG. 9B, the term “inventory tracking” may include inventory checking, such as confirming contents of a cryogenic tank, and/or may include tracking movements of samples. The method is practiced using technological components in various embodiments, including embodiments with one or more computing devices (e.g., specially programmed) and one or more RFID scanners in various arrangements, and RFID tags in various arrangements with cryogenic containers. The method can be embodied in operations of a processor, in some embodiments with human intervention and in some embodiments without human intervention, and can be embodied in systems and also in instructions, for execution by a processor, in tangible, non-transitory, computer-readable media.

In an action 902, cryogenic containers with RFID tags and samples are in cryogenic tanks. Various embodiments described herein for RFID tags, cryogenic containers, samples, and cryogenic tanks are suitable for this action. One example is biological samples for fertility medicine, in goblets in specimen canes with RFID tags attached to or integral with the canes or the goblets. The specimen canes or other cryogenic containers may be placed at least partially submerged in cryogenic fluid in the cryogenic tanks, e.g., by a technician or robotics.

In an action 904, using RFID scanner(s), the RFID tags of cryogenic containers in cryogenic tanks are scanned. This can be accomplished in some embodiments with human intervention, using handheld RFID scanners, in other embodiments with RFID scanners mounted to cryogenic tanks for automated scanning, in both cases with cryogenic containers in situ.

In an action 906, inventory tracking, based on scans, is performed. For example, a processor receives scans, uses a database in memory, or otherwise uses memory, and tracks cryogenic containers and samples based on information from the RFID tags. It should be appreciated that further information may be involved, for example from other database(s), entry by a technician, etc.

In an action 908, reports are generated, based on the inventory tracking. For example, a processor accesses the database or other information in memory, performs various data processing exercises, responds to queries, performs audits, retrieves and reports information based on contents of an entire cryogenic tank or for a specific patient, client or customer, or statistics, etc.

FIG. 9B is a flow diagram of a further method of operation of an RFID system for inventory tracking of cryogenic samples. Related embodiments apply as in FIG. 9A.

In an action 910, cryogenic containers with RFID tags and samples are in cryogenic tanks. Various embodiments described herein for RFID tags, cryogenic containers, samples, and cryogenic tanks are suitable for this action. One example is biological samples for fertility medicine, in goblets in specimen canes with RFID tags attached to or integral with the canes or the goblets. The specimen canes or other cryogenic containers may be placed at least partially submerged in cryogenic fluid in the cryogenic tanks, e.g., by a technician or robotics.

In an action 912, using RFID scanner(s), the RFID tags of cryogenic containers in cryogenic tanks are scanned. This can be accomplished in some embodiments with human intervention, using handheld RFID scanners, in other embodiments with RFID scanners mounted to cryogenic tanks for automated scanning, in both cases with cryogenic containers in situ.

In an action 914, using further RFID scanner(s), RFID tags of arriving or exiting cryogenic containers are scanned and detected. This can be accomplished in some embodiments with RFID scanners mounted at a boundary of a region in which the cryogenic tanks are situated, for example RFID scanners mounted to a doorway that is an entry or exit of the region (e.g., a room).

For example, the further RFID scanner(s) can be configured to have a range that is aligned with a boundary region of the tank(s). In such examples, when a sample is placed into or removed from a tank it is scanned, but when residing in the tank the sample is outside of the range of the further RFID scanner(s) to prevent erroneous scans. Or, further RFID scanner(s) can be arranged or have range adjusted so that samples won't get scanned when moved close to a tank but not actually placed inside the tank. In some embodiments, shielding could be arranged to prevent erroneous scans.

In an action 916, inventory tracking, based on scans, is performed. For example, a processor receives scans, uses a database in memory, or otherwise uses memory, and tracks cryogenic containers and samples based on information from the RFID tags. Inventory tracking includes inventory tracking based on scanning RFID tags of cryogenic containers and cryogenic tank(s), and check-in and checkout of cryogenic containers, based on scanning RFID tags of arriving or exiting cryogenic containers. Either or both of these types of inventory tracking could be with human intervention (e.g., manually initiated RFID scans using handheld RFID scanners), or automated (e.g., using mounted RFID scanners, such as RFID scanners mounted to cryogenic tanks and/or RFID scanners mounted to the boundary of the region in which the cryogenic tanks are situated). It should be appreciated that further information may be involved, for example from other database(s), entry by a technician, etc.

In an action 918, errors are detected in the inventory tracking. For example, the processor (or more generally, system) could compare results of the various scans and detect errors from inconsistencies. Especially, differences between in situ cryogenic container RFID tag scans and arriving/exiting cryogenic container RFID tag scans could indicate error in inventory tracking, and be reported by the system.

In an action 920, reports are generated, based on the inventory tracking. For example, a processor accesses the database or other information in memory, performs various data processing exercises, responds to queries, performs audits, retrieves and reports information based on contents of an entire cryogenic tank or for a specific patient, client or customer, or statistics, etc. In some embodiments, reports are generated to report error detection in the inventory tracking, based on results of the action 918. In some embodiments, the system creates a log for a sample, for example showing historical movements of the sample with timestamps, e.g., removed from tank X at this time and placed in tank Y at that time, etc.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

### B. Microscope System

A system for verifying identity of a sample is provided. A “sample” as used herein refers to any specimen, including a medical sample, a biological sample, such as a cell or a fertility specimen (e.g., egg, semen, embryo). A sample can refer to a specimen, or a specimen and a container containing the specimen therein. Any container can be used to contain a specimen. For example, a sample can be a specimen cane containing a fertility specimen, as described elsewhere in the present disclosure and depicted in FIG. 2. Some biological samples, such as fertility specimens, requires storage under cryogenic conditions (e.g., in a cryogenic liquid, e.g., liquid nitrogen) such that the function of the specimen is maintained when the specimen is brought back to room temperature. A sample may have sample identifiable information (e.g., numbers, letters, codes, pictures, logos, and combinations of any thereof) attached to, integral to, or physically included in the sample, e.g., by way of a label.

The system provided herein combines magnification hardware (e.g., microscope camera) and verification software (e.g., image visualization software, videoconferencing software) to enhance efficiency and accuracy of sample identity verification processes. The system for verifying identity of a sample can include a microscope camera at a central location. A “central” location as used herein refers to a location where the sample physically exists. The microscope camera can capture sample identifiable information that is attached to, integral to, or physically included in the sample (e.g., on a label). The system can further include a first display screen connected to the microscope camera, to visualize the sample identifiable information. The system can further include a first computing device having memory and a processor, connected to the microscope camera. The system can further include a network capable of information transmittal connected to the first computing device. The system can further include a second computing device having memory and a processor connected to the network. The system can further include a second display screen at a remote location. A “remote” location as used herein refers to a location different from where the sample physically exists. The distance between a “remote” location and the central location (where the sample physically exists) can be any distance, including a few feet away to thousands of miles away. A remote location and the central location can be in the same room, same building, same state, same country, different rooms, different buildings, different states, or different countries. The second display screen is connected to the second computing device and arranged to display the sample identifiable information captured by the microscope camera and transmitted through the first computing device, the network, and the second computing device, such that the sample identifiable information can be verified at the remote location based on the remotely provided sample identifiable information, independently from verification of the sample at the central location, enabling two person verification of the sample identity from two different locations.

The microscope camera can be a flexible microscope camera. The microscope camera can have any magnification, such as 2×, 5×, 10×, 15×, 20×, 25×, 30×, 35×, 40×, 45×, 50×, 60×, 70×, 80×, 90×, 100×, and higher. In some embodiments, the microscope camera has a magnification rate of about 5 to about 10 times.

The system can comprise video conferencing capability between the central location and the remote location. For example, the system, through the network connecting the first computing device and the second computing device, can allow sharing a screen at the central location and the remote location, such that the same screen information, e.g., sample identifiable information, can be visualized simultaneously at the central location and the remote location, enabling two person verification of the sample identity from two different locations.

The system can have recording capability of the sample identifiable information captured by the microscope camera. The recording can include capturing (e.g. as screen shots) and storing an image of the sample identifiable information captured by the microscope camera. The recorded information can be placed in an inventory system or a documentation system. For example, the recorded information can be placed in a patient's medical records. The recorded information can be used for quality control or training purposes.

The system can further include a magnifying lens at the central location. The magnifying lens can be used to verify the sample identifiable information, independently from the identification of the sample based on the label displayed on the screen. The system can also include a verification table at the central location, to place the sample thereon for verification. The system can also include a verification bath on the verification table, to place the sample therein for verification.

The sample can be a cryogenic sample, such as a fertility specimen. For example, the sample can be a specimen cane containing a fertility specimen. Details and embodiments of a specimen cane are provided elsewhere in the present disclosure, including FIG. 2. A “cryogenic sample” as used herein refers to a sample that requires storage under a cryogenic condition, e.g., in cryogenic liquid, e.g., liquid nitrogen. A cryogenic sample must be kept under a cryogenic condition during the sample identity verification. To enable this, in some embodiments, the cryogenic sample is transferred from a cryogenic storage container to the verification bath filled with cryogenic liquid (e.g., liquid nitrogen) and submerged under the cryogenic liquid during verification. In some embodiments, the verification table has an adjustable height. The height of the verification table can be adjusted such that the transfer of the cryogenic sample from the cryogenic storage container to the verification bath, and back to the cryogenic storage container, can be performed quickly without affecting the temperature of the sample.

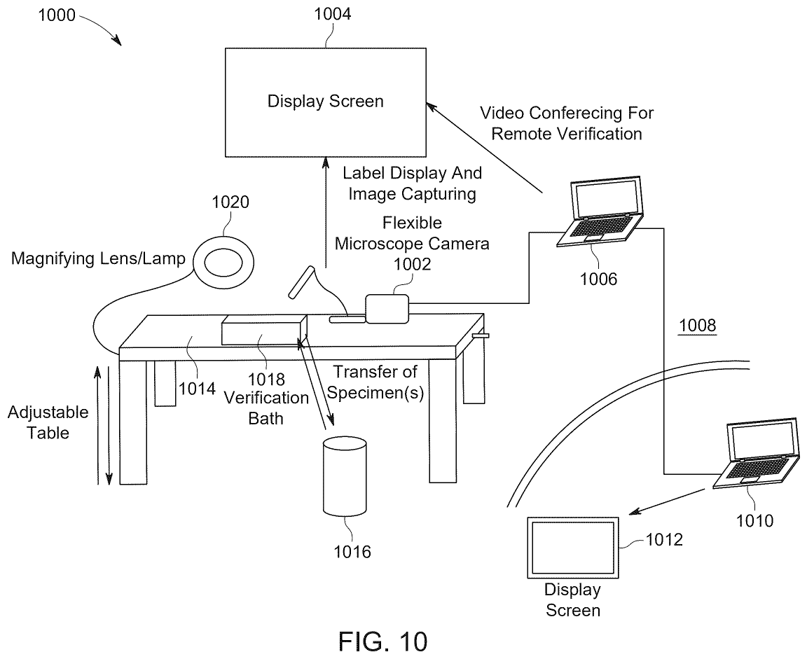

FIG. 10 depicts an embodiment of a system for verifying identity of a sample. The system 1000 for verifying identity of a sample includes a microscope camera 1002 at a central location. The system 1000 can further include a first display screen 1004 connected to the microscope camera 1002, to visualize the sample identifiable information that is attached to, integral to, or physically included in the sample; a first computing device 1006 having memory and a processor, connected to the microscope camera 1002; a network 1008 capable of information transmittal connected to the first computing device 1006; a second computing device 1010 having memory and a processor connected to the network 1008; and a second display screen 1012 at a remote location. The second display screen 1012 is connected to the second computing device 1010 and arranged to display the sample identifiable information captured by the microscope camera 1002 and transmitted through the first computing device 1006, the network 1008, and the second computing device 1010, such that the sample identifiable information can be verified at the remote location based on the remotely provided sample identifiable information, independently from verification of the sample at the central location, enabling two person verification of the sample identity from two different locations. The system 1000 can be set up to have video conferencing capability between the central location and the remote location. For example, the system 1000, through the network 1008 connecting the first computing device 1006 and the second computing device 1010, can allow sharing a screen at the central location and the remote location, such that the same screen information, e.g., sample identifiable information, can be visualized simultaneously on the first display screen 1004 and the second display screen 1012, enabling two person verification of the sample identity from two different locations.

The system 1000 further includes a magnifying lens with lamp function 1012 at the central location. The magnifying lens 1020 can be used to verify the sample identifiable information, independently from the identification of the sample based on the label displayed on the screen. The system 1000 also includes a verification table 1014 with adjustable height and a verification bath 1018 thereon at the central location, to place the sample therein for verification. For identify verification of a cryogenic sample, the sample is transported (e.g., from a clinic) to the system 1000 in a cryogenic storage container 1016. In an effort to reduce sample transfer distance and time from the cryogenic storage container 1016 to the verification bath 1018 and back, thereby minimizing any negative effect (e.g., increase in temperature) on the specimen associated with identity verification, the verification table 1014 is lowered to the level of the cryogenic storage container 1016 to transfer the sample from the cryogenic storage container 1016 to the verification bath 1018 filled with cryogenic liquid (e.g., liquid nitrogen). During identity verification procedure (e.g., remote two-person verification procedure) using the system 1000, the height of the verification table 1018 can be adjusted (e.g., heightened) to an optimal height for the verifiers. The sample is maintained in the cryogenic liquid in the verification bath 1018. After the identity verification, the verification table 1014 is lowered to the level of the cryogenic storage container 1016 to transfer the sample from the verification bath 1018 to the cryogenic storage container 1016.

A method is provided herein for verifying identity of a sample. The method includes the step of placing the sample for visualization under a microscope camera at a central location. The sample has a label attached, integral, or physically included on the surface. The label contains sample identifiable information, e.g., by way of numbers, letters, codes, pictures, logos, and combinations of any thereof. The microscope camera is connected to a first display screen, such that the label is displayed on the screen. The method includes the step of identifying the information on the label displayed on the screen, thereby verifying identity of the sample.

The microscope camera can be a flexible microscope camera. The microscope camera can have any magnification, such as 2×, 5×, 10×, 15×, 20×, 25×, 30×, 35×, 40×, 45×, 50×, 60×, 70×, 80×, 90×, 100×, and higher. In some embodiments, the microscope camera has a magnification rate of about 5 to about 10 times.

The method can further include the steps of providing the sample identifiable information captured by the microscope camera to be displayed on a second display screen at a remote location through an information transmittal system connected to the microscope camera, and verifying the sample identifiable information at the remote location based on the remotely provided sample identifiable information, independently from the identification of the sample at the central location, enabling two person verification at different locations. The information transmittal system can include a first computing device having memory and a processor, and connected to the microscope camera; a network capable of information transmittal and connected to the first computing device; and a second computing device having memory and a processor and connected to the network and the second display screen. The information transmittal system can be a video conferencing system. For example, the video conferencing system can allow sharing a screen at the central location and the remote location, such that the same screen information, e.g., sample identifiable information, can be visualized simultaneously at the central location and the remote location, enabling two person verification of the sample identity from two different locations.

The method can further include recording the sample identifiable information captured by the microscope camera. Recording can include capturing (e.g., as screen shots) and storing an image of the label captured by the microscope camera. The method can further include processing the image to extract the sample identifiable information, e.g., recognizing the text in a photographic image, where the text represents letters, numbers, and/or symbols containing sample identifiable information. The extracted information can be archived.

The method can further include placing the sample identifiable information in an inventory system or a documentation system. The recorded information can be stored or archived for inventory or documentation purposes. For example, the sample identifiable information can be placed in an inventory system or a set of records to facilitate management of the samples stored in the specific storage container or the specific facility, or to keep track of the lineage of the sample generation, transfer, and storage locations. For a medical sample or a biological sample (e.g., fertility specimen), the sample identifiable information can be placed in the patient's medical records as part of the medical information to facilitate clinical management associated with the patient.

The method can further include using the recorded sample identifiable information for quality assurance and/or training. For example, the process of sample identity verification using the method, or the recorded sample identifiable information or process, can be monitored or audited for accuracy; or can be observed to train a personnel to competently conduct the present method.

The method can further include placing the sample for visualization under a magnifying lens at the central location, and locating and/or verifying the sample identifiable information on the label through the magnifying lens. The magnifying lens can assist in identifying location of the label or sample identifiable information on the sample, thereby assisting the sample identity verification steps using the microscope camera. Additionally or alternatively, the sample identifiable information can be verified through the magnifying lens, independently from the verification steps using the microscope camera, offering another layer of verification. The magnifying lens can have an optional lamp function to facilitate the verification process.

The method can further include transferring the sample from a storage container to a verification table prior to the step of placing the sample under the microscope camera, and transferring the sample from the verification table to the storage container after the step of identifying the information on the label.

The sample can be a cryogenic sample, such as a fertility specimen. For example, the sample can be a specimen cane containing a fertility specimen. Details and embodiments of a specimen cane are provided elsewhere in the present disclosure, including FIG. 2. In some embodiments, the cryogenic sample is transferred from a cryogenic storage container to the verification bath on the verification table and filled with cryogenic liquid (e.g., liquid nitrogen), and is submerged under the cryogenic liquid during verification. In some embodiments, the verification table has an adjustable height. The height of the verification table can be adjusted such that the transfer of the cryogenic sample from the cryogenic storage container to the verification bath, and back to the cryogenic storage container, can be performed quickly without affecting the temperature of the sample. In some embodiments, the label has capability of surviving intact in cryogenic storage for at least one year.

The sample identity verification method provided herein can be used as an alternative to or in conjunction with any other sample identity verification process or system, including the RFID tag system (e.g., with CryoFuture Signal app) described elsewhere in the present disclosure. For example, during the two person verification steps of the present method, an additional label for identification, such as an RFID tag, can be attached to or otherwise physically incorporated in the sample, e.g., a specimen cane, to facilitate sample identification, sample verification, documentation, monitoring, and/or training. The present method of direct inspection can also be used to augment another verification method, e.g., the RFID tag system in which the sample identity is verified without physically taking the sample out from the storage container, to address or reduce identification or verification errors, and to clarify identity or lineage of the sample. The present verification method using a microscope camera can be used for intake of new samples without an RFID tag, and/or for sign out of samples with our without an RFID tag stored in the facility to elsewhere (e.g., for use in a medical procedure).

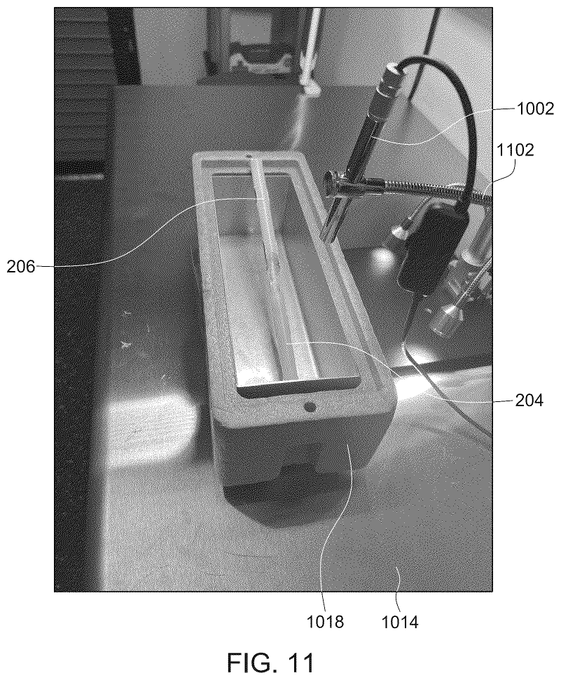

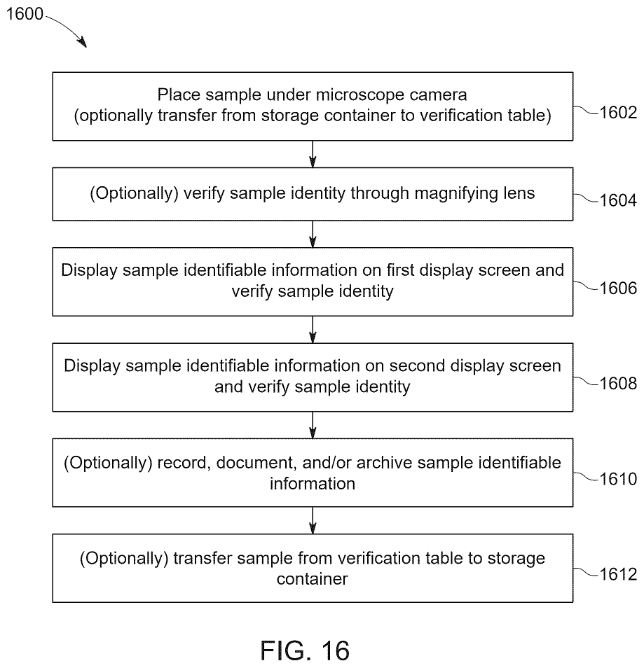

FIG. 16 depicts an embodiment of a method for verifying identity of a sample. Process 1600 begins with step 1602 to place the sample for visualization under a microscope camera 1002 at a central location. In this specific embodiment, the microscope camera has a magnification rate of about 5 to about 10 times. The sample has a label attached, integral, or physically included on the surface. The label contains sample identifiable information, e.g., by way of numbers, letters, codes, pictures, logos, and combinations of any thereof. Step 1602 optionally includes transferring the sample from a storage container (e.g., shipper tank) to a verification table 1014. In certain embodiments, the sample is a cryogenic sample, and this step includes transferring the cryogenic sample from a cryogenic storage container 1016 to a verification bath 1018 filled with cryogenic liquid placed on the verification table 1014. In an effort to reduce sample transfer distance and time from the cryogenic storage container 1016 to the verification bath 1018, the verification table 1014 can be lowered to the level of the cryogenic storage container 1016 to facilitate the sample transfer. After this transfer, the height of the verification table 1018 can be adjusted (e.g., heightened) to an optimal height for the next step. FIG. 11 depicts an example view following step 1602. In this embodiment, the sample is a specimen cane 204 containing a cryogenic specimen, and is fully submerged in liquid nitrogen in the verification bath 1018 placed on the verification table 1014 throughout the verification steps 1604, 1606, and 1608. The specimen cane 204 is angled in the verification bath 1018 to assist in reading specimen labeling in the following steps. A flexible microscope camera 1002 is set up on a flexible camera stand 1102 for visualization of the specimen labeling, allowing for easy manipulation. Once the specimen cane 204 is submerged in liquid nitrogen, the top goblet 206 may be removed as needed, e.g., to verify sample identifiable information on the specimen straw within the specimen cane 204. To maintain a cryogenic condition, a small hole may be created in the top goblet 206 to allow flow of liquid nitrogen into the goblets and eliminate air pocket.

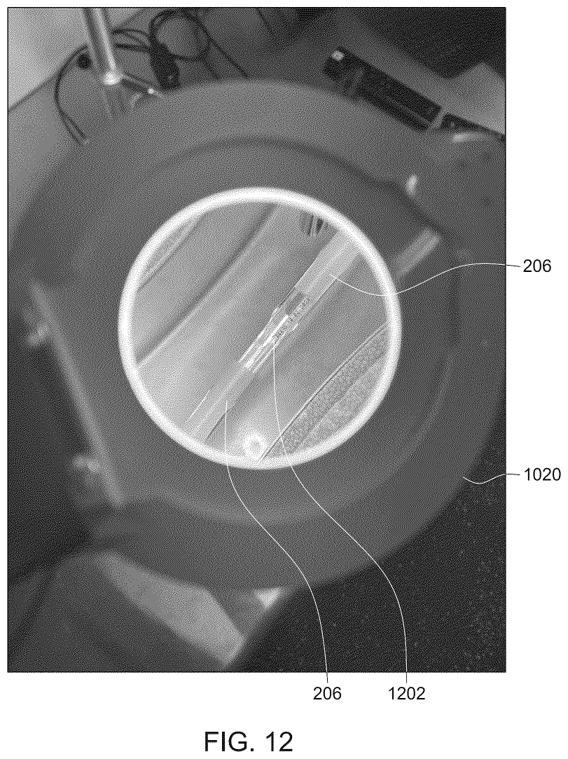

Process 1600 continues to an optional step 1604 to place the sample for visualization under a magnifying lens 1020 at the central location, and assist in verifying the sample identifiable information on the sample label through the magnifying lens. The magnifying lens can have a lamp function to assist in label verification. The verification step 1604 can assist the identification of the sample based on the label displayed on the screen in step 1606 or 1608 by, for example, identifying location of the label or sample identifiable information on the sample. Additionally or alternatively, the verification step 1604 can be conducted based on the sample identifiable information through the magnifying lens, independently from the identification of the sample based on the label displayed on the screen in step 1606 or 1608. FIG. 12 depicts an embodiment of step 1604. A specimen cane is placed under the magnifying lens 1020. Two goblets 206 are separated, revealing a specimen straw 1302 that has been encased in the goblets 206 in the specimen cane 204 under storage condition. The specimen straw 1202 has a label noting sample identifiable information, which is magnified under the magnifying lens 1020.

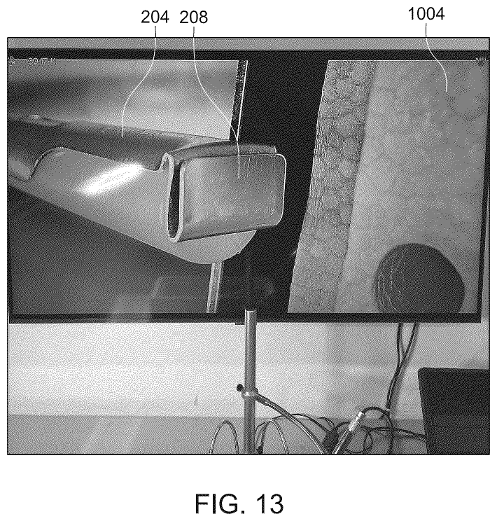

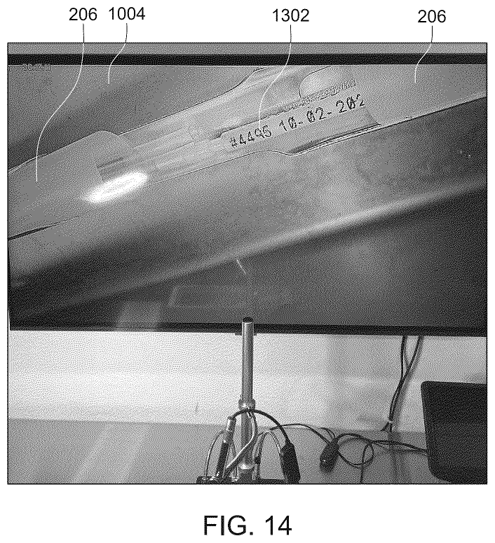

Process 1600 continues to step 1606 to display the sample identifiable information (e.g., on a label) on the first display screen 1004, and to identify the sample identifiable information displayed on the first display screen, thereby verifying identity of the sample. The first display screen can be at the central location (e.g., at physical proximity to the sample). Alternatively, the first display screen can be at a remote location (e.g., not at physical proximity to the sample). FIGS. 13 and 14 depict embodiments of step 1606. FIG. 13 depicts the first display screen 1004, displaying a label on the metal hook 208 of the specimen cane 204 with magnification through the microscope camera. FIG. 14 depicts the first display screen 1004, displaying a label on a specimen straw 1202. Two goblets 206 are separated, revealing the specimen straw 1302 that has been encased in the goblets 206 in the specimen cane under storage condition.

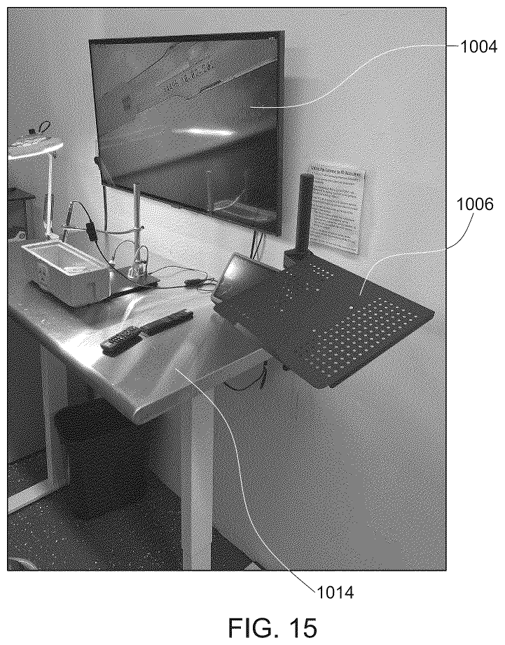

Process 1600 continues to step 1608 to display the sample identifiable information (e.g., on a label) on the second display screen 1012, and to identify the sample identifiable information displayed on the second display screen, thereby verifying identity of the sample. The sample identifiable information (e.g., on the label) captured by the microscope camera 1002 is displayed on a second display screen 1012 at a remote location through an information transmittal system connected to the microscope camera 1002. The information transmittal system includes a first computing device 1006 having memory and a processor, and connected to the microscope camera 1002; a network 1008 capable of information transmittal and connected to the first computing device 1006; and a second computing device 1010 having memory and a processor and connected to the network 1008 and the second display screen 1012. FIG. 15 depicts an embodiment of the configuration of the microscope camera 1002, the first display screen 1004, and the first computing device 1006 on the adjustable table 1014. In specific embodiments, the information transmittal system is a video conferencing system, which allow for sharing a screen at the central location and the remote location, such that the same screen information, e.g., sample identifiable information that is displayed on the first display screen 1004 in FIG. 15, can be visualized simultaneously at the central location and the remote location, enabling two person verification of the sample identity from two different locations. During the verification steps 1606 and 1608, an additional label for identification, such as an RFID tag described elsewhere in the present disclosure, can be attached to or otherwise physically incorporated in the sample, e.g., a specimen cane, to facilitate sample identification, sample verification, documentation, monitoring, and/or training.

Process 1600 continues to an optional step 1608 to record, document, and/or archive sample identifiable information captured by the microscope camera. Recording can include capturing (e.g., as screen shots) and storing an image of the label captured by the microscope camera. The image can be processed to extract the sample identifiable information, e.g., recognizing the text in a photographic image. The extracted information, e.g., text representing letters, numbers, and/or symbols containing sample identifiable information, can be stored or archived. The recorded information can be stored or archived for inventory or documentation purposes, for example in an inventory system or a documentation system. For example, the sample identifiable information can be placed in an inventory system to facilitate management of the samples stored in the specific storage container or the specific facility, or keep track of the lineage of the sample generation, transfer, and storage locations. For a medical sample or a biological sample (e.g., fertility specimen), the sample identifiable information can be placed in the patient's medical records as part of the medical information to facilitate clinical management associated with the patient.

Process 1600 and/or the recorded information can be used for quality assurance by auditing the process or the recorded information. Process 1600 and/or the recorded information can also be used for training a personnel to competently perform the process.

Process 1600 continues to an optional step 1612 to transfer the sample from the verification table 1014 to the storage container (e.g., shipper tank) 1016. In certain embodiments, the sample is a cryogenic sample, and this step includes transferring the cryogenic sample from the verification bath 1018 filled with cryogenic liquid placed on the verification table 1014 to the cryogenic storage container 1016. In an effort to reduce sample transfer distance and time from the verification bath 1018 to the cryogenic storage container 1016, the verification table 1014 can be lowered to the level of the cryogenic storage container 1016 to facilitate the sample transfer. The sample can be stored in the storage container, transferred to another storage container or facility, or transferred to another facility for intervention (e.g., to a clinic for use in medical procedures).

A method is provided herein for monitoring a procedure. A “procedure” as used herein refers to any series of physical actions to achieve a goal. For example, the procedure can be a medical procedure, a surgical procedure, or a procedure to verify identity of a sample. The present method is suited to monitor a procedure that is performed under a microscope.

The method includes capturing the procedure with a microscope camera at a central location, and visualizing the procedure on a first display screen connected to the microscope. A “central” location as used herein refers to a location where the procedure physically takes place. The method can further include visualizing the procedure on a second screen at a remote location through an information transmittal system connected to the microscope camera, thereby monitoring the procedure at the central location and the remote location. A “remote” location as used herein refers to a location different from where the procedure physically takes place. The distance between a “remote” location and the central location (where the procedure physically takes place) can be any distance, including a few centimeters away to thousands of kilometers away. A remote location and the central location can be in the same room, same building, same state, same country, different rooms, different buildings, different states, or different countries.

The microscope camera can be a flexible microscope camera suited to monitor the procedure. The microscope camera can have any magnification, such as 2×, 5×, 10×, 15×, 20×, 25×, 30×, 35×, 40×, 45×, 50×, 60×, 70×, 80×, 90×, 100×, and higher, that is suited to monitor the procedure. In some embodiments, the microscope camera has a magnification rate of about 5 to about 10 times.

The information transmittal system can include a first computing device having memory and a processor, and connected to the microscope camera; a network capable of information transmittal and connected to the first computing device; and a second computing device having memory and a processor, and connected to the network and the second display screen. The information transmittal system can be a video conferencing system. For example, the video conferencing system can allow sharing a screen at the central location and the remote location, such that the same screen information depicting the procedure can be visualized simultaneously at the central location and the remote location, enabling collaboration, quality control, or training from two different locations.

The method can further include recording the procedure through the microscope camera. The method can further include placing the recorded procedure in an inventory system or a documentation system. For example, the procedure can be placed in an inventory system or a set of records to facilitate access to the recorded procedure. For a medical or surgical procedure, the recorded procedure can be placed in the patient's medical records as part of the medical information to facilitate clinical management associated with the patient.

The method can further include conducting quality assurance and/or training using the monitoring or recording of the procedure. The recorded procedure can be reviewed for quality assurance (e.g. auditing) or training purposes.

The procedure provided herein can be a procedure to verify identity of a sample, as described elsewhere in the present disclosure. Verifying can include placing the sample for visualization under the microscope camera, and identifying the information displayed on the first display screen. The sample can have a label attached, integral, or physically included on the surface. The label can contain sample identifiable information, e.g., by way of numbers, letters, codes, pictures, logos, and combinations of any thereof. Verifying can further include providing the sample identifiable information captured by the microscope camera to be displayed on a second display screen in a remote location through the information transmittal system, and verifying the sample identifiable information at the remote location based on the remotely provided sample identifiable information, independently from the identification of the sample at the central location. Verifying can further include placing the sample for visualization under a magnifying lens at the central location, and locating the sample identifiable information (e.g., location of a label) to assist in the verification using the microscope camera. Additionally or alternatively, verifying can include verifying the sample identifiable information on the label through the magnifying lens, independently from the identification of the sample based on the label displayed on the first or second display screens.

The method can further include transferring the sample from a storage container to a verification table prior to the step of placing the sample under the microscope camera, and transferring the sample from the verification table to the storage container after the step of identifying the information on the label.

The sample can be a cryogenic sample, such as a fertility specimen. For example, the sample can be a specimen cane containing a fertility specimen. Details and embodiments of a specimen cane are provided elsewhere in the present disclosure, including FIG. 2. In some embodiments, the cryogenic sample is transferred from a cryogenic storage container to the verification bath on the verification table and filled with cryogenic liquid (e.g., liquid nitrogen), and is submerged under the cryogenic liquid during verification. In some embodiments, the verification table has an adjustable height. The height of the verification table can be adjusted such that the transfer of the cryogenic sample from the cryogenic storage container to the verification bath, and back to the cryogenic storage container, can be performed quickly without affecting the temperature of the sample. In some embodiments, the label has capability of surviving intact in cryogenic storage for at least one year.

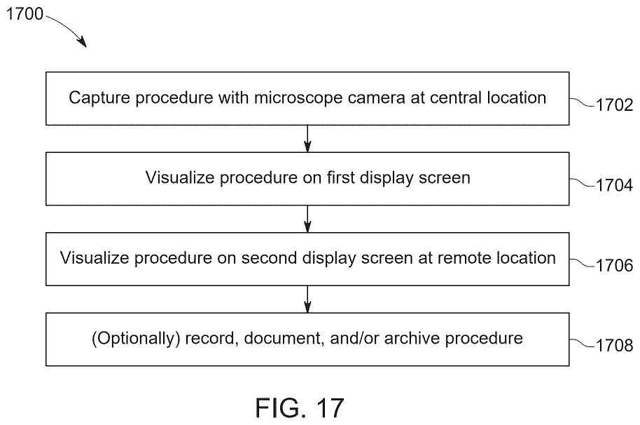

FIG. 17 depicts an embodiment of a method for monitoring a procedure. Process 1700 begins with step 1702 to capture (e.g., visualize) the procedure with a microscope camera at a central location. Process 1700 continues to step 1704 to visualizing the procedure on a first display screen connected to the microscope. Process 1700 then continues to step 1706 to visualize the procedure on a second screen at a remote location. The procedure can be visualized on the second screen through an information transmittal system connected to the microscope camera. The information transmittal system can include a first computing device having memory and a processor and connected to the microscope camera; a network capable of information transmittal and connected to the first computing device; and a second computing device having memory and a processor and connected to the network and the second display screen. The information transmittal system can be a video conferencing system. For example, the video conferencing system can allow sharing a screen at the central location and the remote location, such that the same screen information depicting the procedure can be visualized simultaneously at the central location and the remote location, enabling collaboration, quality control, or training from two different locations.

Process 1700 continues to an optional step 1708 to record, document, and/or archive procedure. can further include recording the procedure through the microscope camera. Recording of the procedure can be stored or archived for inventory or documentation purposes, for example in an inventory system or a documentation system. For example, the procedure can be placed in an inventory system or a set of records to facilitate access to the recorded procedure. For a medical or surgical procedure, the recorded procedure can be placed in the patient's medical records as part of the medical information to facilitate clinical management associated with the patient.

### C. General Considerations

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

The foregoing description, for the purpose of explanation, has been described with reference to specific embodiments. However, the illustrative discussions above are not intended to be exhaustive or to limit the embodiment(s) to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the embodiment(s) is not to be limited to the details given herein, but may be modified within the scope and equivalents of the appended claims.

The section headings used herein are for organizational purposes only and are not to be construed as limiting the subject matter described in any way.

### D. Embodiments

In one aspect, a method for inventory tracking using cryogenic containers is provided. The method includes maintaining samples in cryogenic containers having attached, integral or physically included RFID tags, in cryogenic fluid, scanning, using an RFID scanner, the RFID tags of the cryogenic containers while the cryogenic containers with samples are in the cryogenic fluid, and performing inventory tracking of the samples in the cryogenic containers, with a computing device, based on the scanning the RFID tags of the cryogenic containers.

In some embodiments, the RFID tags have capability of surviving intact in cryogenic storage for at least one year.

In some embodiments, the RFID scanner comprises at least one handheld RFID scanner.

In some embodiments, the method further includes attaching the RFID scanner to a cryogenic tank, wherein the inventory tracking based on the scanning of the RFID tags comprises automated inventory tracking based on the RFID scanner attached to the cryogenic tank scanning the RFID tags of the cryogenic containers in the cryogenic tank without human intervention.

In some embodiments, the method further includes locating a further RFID scanner in a region comprising a plurality of cryogenic tanks, and performing, using the computing device, automated check-in and automated checkout of cryogenic containers, based on scanning, using the further RFID scanner, to detect RFID tags of cryogenic containers that are arriving to or exiting from the region.

In some embodiments, the method further includes performing, using the computing device, verification of the automated check-in and automated checkout of the arriving or exiting cryogenic containers, based on the scanning, using the RFID scanner, the RFID tags of the cryogenic containers while the cryogenic containers with the samples are in the cryogenic fluid.

In some embodiments, each of a plurality of cryogenic containers comprises a specimen cane, the specimen cane includes one or more goblets, and at least one of the one or more goblets includes a biological sample therein.

In some embodiments, each of a plurality of cryogenic containers comprises a specimen cane having one of the RFID tags attached thereto or integral therewith.

In some embodiments, each of a plurality of cryogenic containers comprises a specimen cane, the specimen cane includes an uppermost goblet having one of the RFID tags included therein, attached thereto, or integral therewith, and the specimen cane includes at least one further goblet that includes a biological sample therein.

In one aspect, a system for inventory tracking using cryogenic containers is provided. The system includes RFID tags attached to, integral with, or physically included in cryogenic containers, an RFID scanner, at least one computing device having memory, capability of coupling to the RFID scanner, and a processor arranged to perform a method, comprising receiving, from the RFID scanner, scans of the RFID tags of the cryogenic containers while the cryogenic containers, containing samples, are maintained at least partially submerged in cryogenic fluid, and performing inventory tracking of the samples in the cryogenic containers, using a database in the memory, based on the received scans of the RFID tags of the cryogenic containers.

In some embodiments, the RFID scanner comprises at least one handheld scanner.

In some embodiments, the RFID scanner comprises at least one RFID scanner mountable to a cryogenic tank, and at least one RFID scanner locatable in a region comprising at least one cryogenic tank, wherein the performing the inventory tracking comprises automated check-in and automated checkout of cryogenic containers based on the at least one RFID scanner locatable in the region, and automated verification of the check-in and checkout based on the at least one RFID scanner mountable to the cryogenic tank.

In some embodiments, the RFID tags have capability of surviving intact in cryogenic storage for at least one year.

In some embodiments, each of the cryogenic containers comprises a specimen cane having one or more goblets therein, and one of the RFID tags.

In some embodiments, the performing the inventory tracking comprises real-time inventory tracking and generating reports.

In one aspect, a tangible, non-transitory, computer-readable media having instructions thereupon which, when executed by a processor, cause the processor to perform a method is provided. The method includes receiving, from an RFID scanner, scans of RFID tags of cryogenic containers while the cryogenic containers, having the RFID tags and containing samples, are maintained at least submerged in cryogenic fluid, performing inventory tracking of the samples in the cryogenic containers, using a database in memory, based on the received scans of the RFID tags of the cryogenic containers, and generating reports relating to the inventory tracking of the samples in the cryogenic containers.

In some embodiments, the method includes performing automated inventory tracking of the samples in the cryogenic containers based on the RFID scanner being located at a cryogenic tank in which the cryogenic containers are kept in the cryogenic fluid and the RFID scanner scanning the RFID tags of the cryogenic containers in the cryogenic tank without human intervention.

In some embodiments, the method includes performing automated check-in and automated checkout of the cryogenic containers, based on a further RFID scanner located in a region comprising at least one cryogenic tank, the further RFID scanner to detect RFID tags of cryogenic containers that are arriving to or exiting from the region.

In some embodiments, the method includes performing verification of the automated check-in and automated checkout of the cryogenic containers, based on the received scans of the RFID tags of the cryogenic containers from the RFID scanner, as a handheld RFID scanner.

In some embodiments, the method includes performing automated verification of the automated check-in and automated checkout of the cryogenic containers, based on the received scans of the RFID tags of the cryogenic containers from the RFID scanner, as mounted to the at least one cryogenic tank.

In one aspect, a method for inventory tracking using cryogenic containers is provided. The method includes maintaining samples in cryogenic containers having attached, integral or physically included RFID tags, at least partially submerged in cryogenic fluid in cryogenic tanks, scanning, using at least one RFID scanner, the RFID tags of the cryogenic containers while the cryogenic containers with samples are kept in the cryogenic fluid, scanning, using at least one further RFID scanner, to detect RFID tags of cryogenic containers that are arriving to or exiting from a region comprising the cryogenic tanks, and performing inventory tracking of the samples in the cryogenic containers, including automated check-in and automated checkout, with a computing device, based on the scanning the RFID tags of the cryogenic containers and the scanning the RFID tags of the cryogenic containers that are arriving or exiting.

In some embodiments, the RFID tags have capability of surviving intact in cryogenic storage for at least one year.

In some embodiments, the at least one RFID scanner comprises at least one handheld RFID scanner, and the at least one further RFID scanner is located at a boundary of the region comprising the cryogenic tanks.

In some embodiments, the at least one RFID scanner comprises a plurality of RFID scanners each attached to a respective cryogenic tank, and the inventory tracking comprises automated verification of the check-in and checkout based on the RFID scanners attached to the respective cryogenic tanks.

In some embodiments, the method includes generating, using the computing device, reports based on the inventory tracking including the automated verification of the check-in and checkout.

In some embodiments, the method includes generating, using the computing device, reports based on the inventory tracking including the automated check-in and automated checkout.

In some embodiments, the method further includes generating, using the computing device, reports based on detecting errors in the inventory tracking.

In one aspect, a system for inventory tracking using cryogenic containers is provided. The system includes RFID tags attached to, integral with, or physically included in cryogenic containers, at least one RFID scanner, at least one further RFID scanner, at least one computing device having memory, capability of coupling to the RFID scanners, and a processor arranged to perform a method. The method includes receiving, from the at least one RFID scanner, scans of the RFID tags of the cryogenic containers while the cryogenic containers, containing samples, are maintained at least partially submerged in cryogenic fluid in cryogenic tanks, receiving, from the at least one further RFID scanner, scans that detect RFID tags of cryogenic containers that are arriving to or exiting from a region comprising the cryogenic tanks, and performing inventory tracking of the samples in the cryogenic containers, including automated check-in and automated checkout, based on the received scans of the RFID tags of the cryogenic containers in the cryogenic tanks and the received scans that detect the RFID tags of the cryogenic containers that are arriving or exiting.

In some embodiments, the at least one RFID scanner comprises at least one handheld RFID scanner, and the at least one further RFID scanner is locatable at a boundary of the region comprising the cryogenic tanks.

In some embodiments, each of the at least one RFID scanner is mountable to a respective cryogenic tank, and the at least one further RFID scanner is locatable at a boundary of the region comprising the cryogenic tanks.

In some embodiments, the RFID tags have capability of surviving intact in cryogenic storage for at least one year.

In some embodiments, each of the cryogenic containers comprises a specimen cane, each specimen cane includes one or more goblets, and at least one of the one or more goblets includes a biological sample therein.

In some embodiments, each of the cryogenic containers comprises a specimen cane having one of the RFID tags attached thereto or integral therewith.

In some embodiments, each of the cryogenic containers comprises a specimen cane, each specimen cane includes an uppermost goblet having one of the RFID tags included therein, attached thereto, or integral therewith, and each specimen cane includes, below the uppermost goblet, at least one further goblet that includes a biological sample therein, wherein the uppermost goblet is arranged to prevent spillage or loss of the at least one further goblet.

In one aspect, a tangible, non-transitory, computer-readable media having instructions thereupon which, when executed by a processor, cause the processor to perform a method is provided. The method includes receiving, from at least one RFID scanner, scans of RFID tags of cryogenic containers while the cryogenic containers, having the RFID tags and containing samples, are maintained at least partially submerged in cryogenic fluid in cryogenic tanks, receiving, from at least one further RFID scanner, scans that detect RFID tags of cryogenic containers that are arriving to or exiting from a region comprising the cryogenic tanks, performing inventory tracking of the samples in the cryogenic containers, including automated check-in and automated checkout, based on the received scans of the RFID tags of the cryogenic containers in the cryogenic tanks and the received scans that detect the RFID tags of the cryogenic containers that are arriving or exiting, and generating reports relating to the inventory tracking of the samples in the cryogenic containers.

In some embodiments, the at least one RFID scanner is to be at least one handheld RFID scanner, the scans of the RFID tags of the cryogenic containers kept in the cryogenic tanks are expected to be performed with human intervention, and the receiving, from the at least one RFID scanner, is based on the human intervention initiating the scans using the at least one handheld RFID scanner.

In some embodiments, the at least one RFID scanner is to be a plurality of RFID scanners each mountable to a respective one of the cryogenic tanks, and the performing the inventory tracking comprises automated inventory tracking without human intervention, based on the plurality of RFID scanners as mounted to the cryogenic tanks and the at least one further RFID scanner as located at a boundary of the region comprising the cryogenic tanks.

In some embodiments, the method includes reporting errors in the inventory tracking, based on detecting differences between the received scans of the RFID tags of the cryogenic containers in the cryogenic tanks, and the received scans that detect the RFID tags of the cryogenic containers that are arriving or exiting.

In some embodiments, the method includes performing verification of the automated check-in and automated checkout of the cryogenic containers, based on the received scans of the RFID tags of the cryogenic containers in the cryogenic tanks.

In some embodiments, the method includes generating reports based on the inventory tracking, for display.

In one aspect, a method for verifying identity of a sample is provided. The method includes placing the sample for visualization under a microscope camera at a central location, and identifying the information on the label displayed on the screen, thereby verifying identity of the sample. The sample has an attached, integral, or physically included label. The label contains sample identifiable information thereon. The microscope camera is connected to a first display screen, such that the label is displayed on the first display screen.

In some embodiments, the microscope camera is a flexible microscope camera. In some embodiments, the microscope camera has a magnification rate of about 5 to about 10 times.

In some embodiments, the method further includes providing the sample identifiable information captured by the microscope camera to be displayed on a second display screen at a remote location through an information transmittal system connected to the microscope camera, and verifying the sample identifiable information at the remote location based on the remotely provided sample identifiable information, independently from the identification of the sample at the central location. In some embodiments, the information transmittal system comprises: a first computing device having memory and a processor, the first computing device connected to the microscope camera; a network capable of information transmittal and connected to the first computing device; and a second computing device having memory and a processor and connected to the network and the second display screen. In some embodiments, the information transmittal system is a video conferencing system.

In some embodiments, the method further includes recording the sample identifiable information captured by the microscope camera. In some embodiments, the recording includes capturing and storing an image of the label captured by the microscope camera.

In some embodiments, the method further includes processing the image to extract the sample identifiable information.

In some embodiments, the method further includes placing the sample identifiable information in an inventory system or a documentation system. The sample can be a medical sample, and the documentation system can include medical records.

In some embodiments, the method further includes using the recorded sample identifiable information for quality assurance and/or training.

In some embodiments, the method further includes placing the sample for visualization under a magnifying lens at the central location, and locating and/or verifying the sample identifiable information on the label through the magnifying lens.

In some embodiments, the method further includes, prior to the step of placing the sample under the microscope camera, transferring the sample from a storage container to a verification table, and after the step of identifying the information on the label, transferring the sample from the verification table to the storage container.

In some embodiments, the verification table has an adjustable height.

In some embodiments, the sample is a cryogenic sample. In some embodiments, the sample is a specimen cane containing a fertility specimen. In some embodiments, the label has capability of surviving intact in cryogenic storage for at least one year. In some embodiments, the sample is immersed in cryogenic liquid in a verification bath during the steps of verifying identity of the sample.

In one aspect, a system for verifying identity of a sample is provided. The system includes a microscope camera at a central location, to capture sample identifiable information that is attached to, integral to, or physically included in the sample; a first display screen connected to the microscope camera, to visualize the sample identifiable information; a first computing device having memory and a processor, the first computing device connected to the microscope camera; a network capable of information transmittal connected to the first computing device; a second computing device having memory and a processor connected to the network; and a second display screen at a remote location. The second display screen is connected to the second computing device and arranged to display the sample identifiable information captured by the microscope camera and transmitted through the first computing device, the network, and the second computing device, such that the sample identifiable information can be verified at the remote location based on the remotely provided sample identifiable information, independently from verification of the sample at the central location.

In some embodiments, the microscope camera is a flexible microscope camera. In some embodiments, the microscope camera has a magnification rate of about 5 to about 10 times. In some embodiments, the system includes video conferencing capability between the central location and the remote location. In some embodiments, the system includes recording capability of the sample identifiable information captured by the microscope camera. In some embodiments, the recording includes capturing and storing an image of the sample identifiable information captured by the microscope camera.

In some embodiments, the system further includes: a magnifying lens at the central location, to locate and/or verify the sample identifiable information; a verification table at the central location, to place the sample thereon for verification; and/or a verification bath on the verification table, to place the sample therein for verification. In some embodiments, the verification table has an adjustable height.

In some embodiments, the sample is a cryogenic sample, such as a specimen cane containing a fertility specimen. In some embodiments, the verification bath is capable of holding cryogenic liquid.

In one aspect, a method for monitoring a procedure is provided. The method includes: capturing the procedure with a microscope camera at a central location; visualizing the procedure on a first display screen connected to the microscope; and visualizing the procedure on a second screen at a remote location through an information transmittal system connected to the microscope camera, thereby monitoring the procedure at the central location and the remote location.

In some embodiments, the microscope camera is a flexible microscope camera. In some embodiments, the microscope camera has a magnification rate of about 5 to about 10 times. In some embodiments, the information transmittal system comprises: a first computing device having memory and a processor, the first computing device connected to the microscope camera; a network capable of information transmittal and connected to the first computing device; and a second computing device having memory and a processor and connected to the network and the second display screen. In some embodiments, the information transmittal system is a video conferencing system.

In some embodiments, the method further includes recording the procedure through the microscope camera. In some embodiments, the method further includes placing the recorded procedure in an inventory system or a documentation system. In some embodiments, the sample is a medical sample, and the documentation system comprises medical records. In some embodiments, the method further includes conducting quality assurance and/or training using the monitoring or recording of the procedure.

In some embodiments, the procedure includes verifying identity of a sample.

Verifying can include: placing the sample for visualization under the microscope camera; identifying the information on the label displayed on the first display screen; providing the sample identifiable information captured by the microscope camera to be displayed on a second display screen through the information transmittal system; and verifying the sample identifiable information at the remote location based on the remotely provided sample identifiable information, independently from the identification of the sample at the central location. The sample has an attached, integral, or physically included label on the surface. The label contains sample identifiable information thereon, such that the label is displayed on the first display screen.

In some embodiments, the verifying further includes placing the sample for visualization under a magnifying lens at the central location, and locating and/or verifying the sample identifiable information on the label through the magnifying lens.

In some embodiments, the method further includes, prior to the step of placing the sample under the microscope camera, transferring the sample from a storage container to a verification table, and after the step of identifying the information on the label, transferring the sample from the verification table to the storage container.

In some embodiments, the verification table has an adjustable height.

In some embodiments, the sample is a cryogenic sample, such as a specimen cane containing a fertility specimen. In some embodiments, the label has capability of surviving intact in cryogenic storage for at least one year. In some embodiments, the sample is immersed in cryogenic liquid in a verification bath during the steps of verifying identity of the sample.

What is claimed is:

1. A system for inventory tracking using cryogenic containers, comprising:
RFID tags attached to, integral with, or physically included in cryogenic containers;
an RFID scanner;
at least one computing device having memory, capability of coupling to the RFID scanner, and a processor arranged to perform a method, comprising:
receiving, from the RFID scanner, scans of the RFID tags of the cryogenic containers while the cryogenic containers, containing samples, are kept in cryogenic fluid; and
performing inventory tracking of the samples in the cryogenic containers, using a database in the memory, based on the received scans of the RFID tags of the cryogenic containers.

2. The system of claim 1, wherein the RFID scanner comprises:
at least one RFID scanner mounted to a cryogenic tank; and
at least one RFID scanner located in a region comprising at least one cryogenic tank, wherein the performing the inventory tracking comprises automated check-in and automated checkout of cryogenic containers based on the at least one RFID scanner locatable in the region, and automated verification of the check-in and checkout based on the at least one RFID scanner mountable to the cryogenic tank.

3. The system of claim 1, wherein:
each of the cryogenic containers comprises a specimen cane having one or more goblets therein and one of the RFID tags.

4. The system of claim 1, wherein:
the performing the inventory tracking comprises real-time inventory tracking and generating reports.

5. The system of claim 1, wherein:
each of the cryogenic containers comprises a specimen cane;
each specimen cane includes an uppermost goblet having one of the RFID tags included therein, attached thereto, or integral therewith; and
each specimen cane includes, below the uppermost goblet, at least one further goblet that includes a biological sample therein, wherein the uppermost goblet is arranged to prevent spillage or loss of the at least one further goblet.

6. A method for inventory tracking using cryogenic containers, the method comprising:
maintaining samples in cryogenic containers having attached, integral or physically included RFID tags, the cryogenic containers being at least partially submerged in cryogenic fluid;
scanning, using an RFID scanner, the RFID tags of the cryogenic containers while the cryogenic containers containing samples are at least partially submerged in the cryogenic fluid; and
performing inventory tracking of the samples in the cryogenic containers, with a computing device, based on the scanning the RFID tags of the cryogenic containers.

7. The method of claim 6, further comprising:
attaching the RFID scanner to a cryogenic tank, wherein the inventory tracking based on the scanning of the RFID tags comprises automated inventory tracking based on the RFID scanner attached to the cryogenic tank scanning the RFID tags of the cryogenic containers in the cryogenic tank without human intervention.

8. The method of claim 6, further comprising:
locating a further RFID scanner in a region comprising cryogenic tanks; and
performing, using the computing device, automated check-in and automated checkout of cryogenic containers, based on scanning, using the further RFID scanner, to detect RFID tags of cryogenic containers that are arriving to or exiting from the region.

9. The method of claim 6, further comprising:
performing, using the computing device, verification of the automated check-in and automated checkout of the arriving or exiting cryogenic containers, based on the scanning, using the RFID scanner, the RFID tags of the cryogenic containers while the cryogenic containers with the samples are in the cryogenic fluid.

10. The method of claim 9, further comprising:
generating, using the computing device, reports based on the inventory tracking including the automated check-in and automated checkout and reports based on detecting errors in the inventory tracking.

11. The method of claim 6, wherein:
each of the cryogenic containers comprises a specimen cane having one of the RFID tags attached thereto or integral therewith.

12. A tangible, non-transitory, computer-readable media having instructions thereupon which, when executed by a processor, cause the processor to perform a method comprising:
receiving, from an RFID scanner, scans of RFID tags of cryogenic containers while the cryogenic containers, having the RFID tags and containing samples, are maintained at least partially submerged in cryogenic fluid;
performing inventory tracking of the samples in the cryogenic containers, using a database in memory, based on the received scans of the RFID tags of the cryogenic containers; and
generating reports relating to the inventory tracking of the samples in the cryogenic containers.

13. The tangible, non-transitory, computer-readable media of claim 12, wherein the method further comprises:
performing automated inventory tracking of the samples in the cryogenic containers based on the RFID scanner being located at a cryogenic tank in which the cryogenic containers are kept in the cryogenic fluid and the RFID scanner scanning the RFID tags of the cryogenic containers in the cryogenic tank without human intervention.

14. The tangible, non-transitory, computer-readable media of claim 12, wherein the method further comprises:
performing automated check-in and automated checkout of the cryogenic containers, based on a further RFID scanner located in a region comprising at least one cryogenic tank, the further RFID scanner to detect RFID tags of cryogenic containers that are arriving to or exiting from the region.

15. The tangible, non-transitory, computer-readable media of claim 14, wherein the method further comprises:
performing verification of the automated check-in and automated checkout of the cryogenic containers, based on the received scans of the RFID tags of the cryogenic containers from the RFID scanner, as a handheld RFID scanner; or
performing automated verification of the automated check-in and automated checkout of the cryogenic containers, based on the received scans of the RFID tags of the cryogenic containers from the RFID scanner, as mounted to the at least one cryogenic tank.

16. The tangible, non-transitory, computer-readable media of claim 12, wherein the method further comprises:
reporting errors in the inventory tracking, based on detecting differences between the received scans of the RFID tags of the cryogenic containers in the cryogenic tanks, and the received scans that detect the RFID tags of the cryogenic containers that are arriving or exiting.

17. The tangible, non-transitory, computer-readable media of claim 12, wherein the method further comprises:
generating reports based on the inventory tracking, for display.

18. A method for verifying identity of a sample, the method comprising:
placing the sample for visualization under a microscope camera at a central location, the sample having an attached, integral, or physically included label, the label containing sample identifiable information thereon, the microscope camera connected to a first display screen, such that the label is displayed on the first display screen;
identifying the information on the label displayed on the first display screen;
providing the sample identifiable information captured by the microscope camera to be displayed on a second display screen at a remote location through an information transmittal system connected to the microscope camera, and
verifying the sample identifiable information at the remote location based on the remotely provided sample identifiable information, independently from the identification of the sample at the central location.

19. A system for verifying identity of a sample, the system comprising:
a microscope camera at a central location, to capture sample identifiable information that is attached to, integral to, or physically included in the sample and a first display screen connected to the microscope camera, to visualize the sample identifiable information;
a first computing device having memory and a processor, the first computing device connected to the microscope camera; and
a second display screen at a remote location, the second display screen connected to the second computing device and arranged to display the sample identifiable information captured by the microscope camera and transmitted through the first computing device, the network, and the second computing device, such that the sample identifiable information is verified at the remote location based on the remotely provided sample identifiable information, independently from verification of the sample at the central location.

20. A method for monitoring a procedure, the method comprising:
capturing the procedure with a microscope camera;
visualizing the procedure on a first display screen connected to the microscope; and
visualizing the procedure on a second screen at a remote location through an information transmittal system connected to the microscope camera, thereby monitoring the procedure at the central location and the remote location,
the procedure comprising verifying identity of a sample, the verifying comprising:
placing the sample for visualization under the microscope camera, the sample having an attached, integral, or physically included label on the surface, the label containing sample identifiable information thereon, such that the label is displayed on the first display screen;
identifying the information on the label displayed on the first display screen;
providing the sample identifiable information captured by the microscope camera to be displayed on a second display screen through the information transmittal system; and
verifying the sample identifiable information at the remote location based on the remotely provided sample identifiable information, independently from the identification of the sample at the central location.
